(19) United States
(12) Patent Application Publication
(10) Pub. No.: US 2023/0402849 A1
(43) Pub. Date: Dec. 14, 2023

(54) APPARATUS AND METHOD FOR ESS TO SUPPLEMENT GRID POWER

(71) Applicant: STANDARD ENERGY INC., Daejeon (KR)

(72) Inventors: Dong Young Lee, Daejeon (KR); Sang Hyun Park, Daejeon (KR)

(73) Assignee: STANDARD ENERGY INC., Daejeon (KR)

(21) Appl. No.: 18/208,941

(22) Filed: Jun. 13, 2023

(30) Foreign Application Priority Data
Jun. 13, 2022 (KR) 10-2022-0071734
Aug. 4, 2022 (KR) 10-2022-0097420
Aug. 26, 2022 (KR) 10-2022-0107295
Nov. 8, 2022 (KR) 10-2022-0147628
Feb. 24, 2023 (KR) 10-2023-0025362

(51) Int. Cl. H02J 3/32; B60L 53/53; B60L 53/63; B60L 53/62; H02J 3/00; H02J 7/00; H02J 7/34

(52) U.S. Cl. CPC H02J 3/32; B60L 53/53; B60L 53/63; B60L 53/62; H02J 3/0012; H02J 7/0048; H02J 7/0063; H02J 7/00712; H02J 7/342; H02J 2203/10

(57) ABSTRACT

A method for electric vehicle (EV) charging includes receiving power from at least one of a power grid and an energy storage system; performing an EV charging procedure through a charger using the received power; and performing, during the EV charging procedure, one of enabling charging the energy storage system from the power grid, and switching from discharging to charging of the energy storage system. An EV charging system includes a secondary battery for charging/discharging; an input unit receiving power from a power grid in order to charge the secondary battery; an output unit providing the power grid power to a charger for charging an electric vehicle by discharging the secondary battery; and a control unit to control a state of charge of the secondary battery when EV charging starts and a state of charge of the secondary battery when EV charging ends and to perform the EV charging procedure.

### CROSS-REFERENCE TO RELATED APPLICATIONS

This application claims the priority of Korean Patent Application Nos. 10-2022-0071734 filed on Jun. 13, 2022, 10-2022-0097420 filed on Aug. 4, 2022, 10-2022-0107295 filed on Aug. 26, 2022, 10-2022-0147628 filed on Nov. 8, 2022, and 10-2023-0025362 filed on Feb. 24, 2023, in the Korean Intellectual Property Office, the disclosure of which is incorporated herein by reference.

### BACKGROUND OF THE DISCLOSURE

### Technical Field

The present disclosure relates to an integrated system in which an energy storage system (ESS) and a charger are combined, and more particularly, to a system and a method for electric energy meter panel management, which judge and manage a power flow of an entire system in which an energy storage system (ESS) is installed.

### Background Art

An energy storage system (ESS) is a system that stores electricity in a battery and the like, and then supplies power to a grid. The energy storage system can perform charging and discharging.

In recent years, as the use of electric vehicles has expanded, an electric vehicle charger is disposed in various spaces. However, the use of the electric vehicle charger can increase electricity consumption of the grid and influence other electricity consumption in the corresponding space. In particular, when the electricity consumption is soaring, there is a problem in which the use of the electric vehicle charger is limited.

Therefore, a method for stably performing charging in a space in which the charger is disposed and providing a system therefor is required.

### SUMMARY OF THE DISCLOSURE

An object to be achieved by the present disclosure is to provide a system for electric vehicle charging, in which an energy storage system assists power use of a charger to stabilize power supply of a grid, and is driven by linking ESS power.

Another object to be achieved by the present disclosure is to provide a system and a method for electric energy meter panel management, which judge and manage a power flow of an entire system in which an ESS is installed.

An additional object to be achieved by the present disclosure is to provide a system and a method for electric energy meter panel management, which recognize an emergency situation, use electric energy more efficiently, and deviate from dependency on a specific apparatus.

The object of the present disclosure is not limited to the aforementioned object, and other objects, which are not mentioned above, will be apparent to a person having ordinary skill in the art from the following description.

According to an aspect of the present disclosure, provided is an energy storage system (ESS) management method including: performing a control so as to prevent a power source of a facility or equipment connected to the power grid from being interrupted by controlling an output of the ESS based on an electric energy of the power grid or so as for the ESS to cope with a total power situation of the power grid by sensing an abnormal operation.

According to another aspect of the present disclosure, provided is an energy storage system (ESS) management method which in a battery charging management system including an energy storage system (ESS), includes: a step of confirming all of a first electric energy used in a power grid, a second electric energy required for a charger used in electric vehicle charging, and a third electric energy used in a load of other areas connected to the power grid; and a step of selectively performing a discharging mode for supplement the power of the power grid or a diagnosis mode of sensing a diagnosis necessary and giving a warning according to a confirmation result of the electric energies.

According to another aspect of the present disclosure, provided is an energy storage system (ESS) management system including: a power conversion unit receiving and converting power from a power grid; an energy storage system (ESS) connected to the power grid and the power conversion unit; and a sensor network implemented to perform power flow judgment and management of an entire system in which the energy storage system (ESS) is installed.

When exemplary embodiments of the present disclosure are implemented, an energy storage system assists power use of a charger to stabilize power supply of a grid, and as a result, the charger may provide a stable electric vehicle charging service.

When the exemplary embodiments of the present disclosure are implemented, a system may be provided, which is capable of managing and controlling electric energy of an entire region of the grid.

When the exemplary embodiments of the present disclosure are implemented, a system may be provided, which is capable of supplying ESS related power and immediately responding to an emergency situation of a load.

The objects of the present disclosure are not limited to the aforementioned objects, and other objects, which are not mentioned above, will be apparent to a person having ordinary skill in the art from the following description.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1A is a conceptual diagram illustrating a power supply configuration including a power grid, an energy storage system, and other electric devices according to an exemplary embodiment of the present disclosure;

FIG. 1B is graphical representations of outputs according to time at points A, B, and C of FIG. 1A according to an embodiment of the present disclosure;

FIG. 1C is a conceptual configuration diagram of a system according to exemplary embodiments of the present disclosure;

FIGS. 2A, 2B, and 2C are graphical representations respectively illustrating a charger output, an ESS output, and a state of charge (SoC) of an ESS according to exemplary embodiments of the present disclosure;

FIG. 3A is a diagram illustrating a configuration and an operation of a system for electric energy meter panel management, which judges and manages a power flow of an entire system in which an ESS is installed according to additional exemplary embodiments of the present disclosure;

FIG. 3B is a diagram illustrating a configuration and an operation of a system for electric energy meter panel management, which judges and manages a power flow of an entire system in which an ESS is installed according to additional exemplary embodiments of the present disclosure;

FIG. 4A is a diagram illustrating a configuration and an operation of a system for electric energy meter panel management, which judges and manages a power flow of an entire system in which an ESS is installed according to additional exemplary embodiments of the present disclosure;

FIG. 4B is a diagram illustrating a configuration and an operation of a system for electric energy meter panel management, which judges and manages a power flow of an entire system in which an ESS is installed according to additional exemplary embodiments of the present disclosure;

FIG. 5 is a conceptual diagram illustrating power supply configurations in which an energy storage system is disposed in a space and in which other electric devices are disposed according to an exemplary embodiment of the present disclosure;

FIG. 6 is a diagram illustrating a configuration in which the charger receives power from the energy storage system and a power distribution device according to an exemplary embodiment of the present disclosure;

FIG. 7 is a diagram illustrating a configuration of the energy storage system according to an exemplary embodiment of the present disclosure;

FIG. 8 is a flowchart illustrating a process in which a controller controls the energy storage system according to electric energy in a grid according to an exemplary embodiment of the present disclosure;

FIG. 9 is a conceptual diagram illustrating layouts and operations of the energy storage system and the charger according to an exemplary embodiment of the present disclosure;

FIG. 10 is a conceptual diagram illustrating layouts and operations of the energy storage system and the charger according to another exemplary embodiment of the present disclosure;

FIG. 11 is a flowchart illustrating a process in which the energy storage system operates in response to a power use increase situation in the grid according to an exemplary embodiment of the present disclosure;

FIG. 12 is a diagram illustrating the configuration of the energy storage system according to another exemplary embodiment of the present disclosure;

FIG. 13 is a diagram illustrating a configuration of the charger according to an exemplary embodiment of the present disclosure;

FIG. 14 is a conceptual view exemplarily illustrating an operation state management range when a monitoring level is constituted by levels 1 to 4;

FIG. 15 is a conceptual view exemplarily illustrating a system according to an exemplary embodiment of the present disclosure; and

FIG. 16 is a conceptual diagram illustrating the charging/discharging of the ESS according to an exemplary embodiment of the present disclosure.

### DETAILED DESCRIPTION OF THE EMBODIMENT

Advantages and features of the present disclosure, and methods for accomplishing the same will be more clearly understood from exemplary embodiments described in detail below with reference to the accompanying drawings. However, the present disclosure is not limited to the exemplary embodiments set forth below, and will be embodied in various different forms. The present exemplary embodiments are just for rendering the disclosure of the present disclosure complete and are set forth to provide a complete understanding of the scope of the invention to a person with ordinary skill in the technical field to which the present disclosure pertains, and the present disclosure will only be defined by the scope of the claims. Throughout this specification, the same reference numerals denote the same elements.

Further, in describing the present disclosure, a detailed description of known related configurations and functions may be omitted to avoid unnecessarily obscuring the subject matter of the present disclosure.

In describing the components of the present disclosure, terms including first, second, A, B, (a), (b), and the like may be used. These terms are just intended to distinguish the components from other components, and the terms do not limit the nature, sequence, order, number, or the like of the components. When it is disclosed that any component is “connected”, “coupled”, or “linked” to other components, it should be understood that the component may be directly connected or linked to other components, but another component may be “interposed” between respective components, or the respective components may be “connected”, “coupled”, or “linked” via another component.

Hereinafter, in the present specification, technology in which an energy storage system installed in a space such as a building or a house, a subway, a public space, etc., controls charging or discharging of the energy storage system according to an electricity use situation of other electric devices in the space will be described. Further, technology in which the energy storage system controls a charger according to the electricity use situation will be described. In addition, technology in which when power use loads of other electric devices in the space increase, the energy storage system supplies power to the other electric devices will be described.

In general, the energy storage system (ESS) is constituted by a battery, a battery management system (BMS), a power conversion unit, an energy management system (EMS), etc. The battery includes one or more cells, and a plurality of cells may constitute one module, and a plurality of modules may form one rack. The energy storage system (ESS) configured as such is connected to a power network, an electricity network, a power grid, etc., to receive the power.

The energy storage system (ESS) may be used for charging the electric vehicle (EV). Here, there are states-of-charge (SoCs) in a battery applied to the energy storage system (ESS) and a battery applied to the inside of the electric vehicle (EV), respectively, and a background thereof is described as below.

First, a charging/discharging rate (C-rate) of the battery should be appreciated. A charging rate of the battery and/or a discharging rate of the battery may be controlled by the charging/discharging rate (C-rate). The charging/discharging rate (C-rate) means measurement of current used for charging and/or discharging the battery. As an example, charging a specific battery at 1C-rate or 1C means that a battery having a capacity of 10 Ah (i.e., an amount when current of 10 amperes (A) flows for 1 hour) may discharge 10 amperes (A) for 1 hour while the battery is completely charged. In this way, the charging rate of the battery may also be represented by C-rate.

When a battery charged with a specific C-rate is measured, the corresponding state of charge (SoC) may be confirmed. Various controls for the charging may be performed by confirming SoC of an internal battery of the energy storage system (ESS), SoC of an internal battery of the electric vehicle (EV), and the like when charging an electric vehicle (EV) by using the energy storage system (ESS).

Exemplary embodiments of the present disclosure to be described below relate to a system control required for charging the electric vehicle (EV) by using the integrated system that applies the charger of the electric vehicle (EV) to the energy storage system (ESS), and the present inventors provides the system control by considering features technically improved as compared with a conventional or existing system configuration and control of the energy storage system (ESS). The feature of the present disclosure may also be expressed as an electric vehicle charging system driven by linking ESS power.

Hereinafter, the feature of the present disclosure will be described in more detail with reference to the exemplary embodiments.

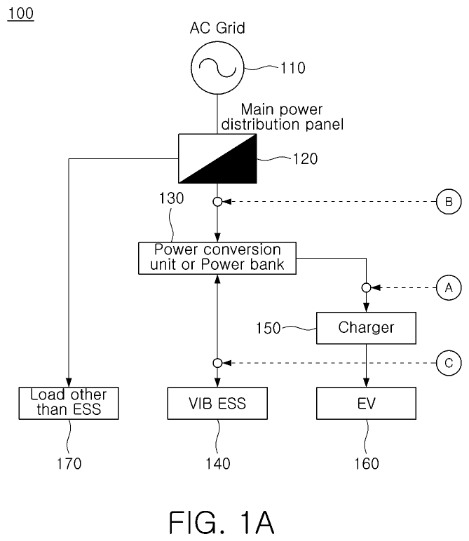

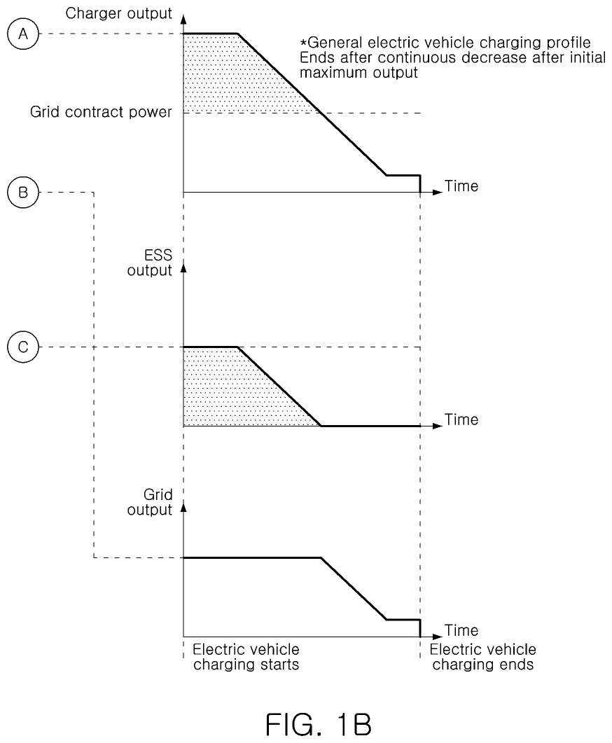

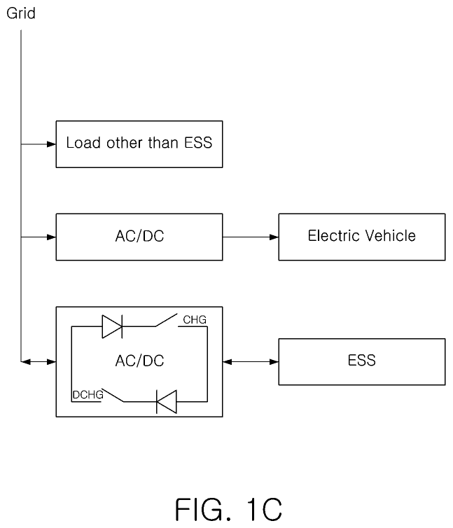

FIG. 1A is a conceptual diagram illustrating a power supply configuration including a power grid 110, an energy storage system 140, and other electric devices 120, 130, 150, 160, and 170 in a power supply system 100 according to an exemplary embodiment of the present disclosure.

In general, the power supply system 100 includes a main distribution panel 120 receiving power, i.e., alternating current (AC) from the power grid 110, and the corresponding power is distributed and provided to the power conversion unit, a power bank, or a similar power conversion equipment 130. Meanwhile, the main distribution panel 120 is connected even to a load 170 other than the ESS to supply the power.

The power conversion equipment 130 may be operatively connected to the energy storage system 140 such as a VIB ESS, and provides a required control to transfer or receive the power. Further, the power conversion equipment 130 may be connected to the charger 150, and the charger 150 may be connected to the electric vehicle (EV) 160 or other objects requiring charging. The electric vehicle (EV) 160 may selectively receive at least one of the power provided by the power grid 110 and the power provided by the energy storage system 140 under the control of the power conversion equipment 130.

Here, at least one of the main distribution panel 120, the power conversion equipment 130, the energy storage system 140, the charger 150, the electric vehicle (EV) 160, and a load 170 other than the ESS may be installed inside or next to a designated place, e.g., a specific building.

The power supply system 100 is preferably installed and controlled to supply grid power to a specific building, and also additionally perform electric vehicle charging together. Therefore, outputs for portions marked A, B, and C in FIG. 1A will be described in more detail in FIG. 1B.

FIG. 1B is graphical representations of outputs according to time at points A, B, and C of FIG. 1A.

FIGS. 1A and 1B, which illustrate a configuration in which the ESS and the charger are combined correspond to technology that assists with the ESS and charges the ESS after charging ends so as not to exceed contract power of the grid.

A graph of output A shows a charger output over time, and the electric vehicle is charged while receiving the power from the grid and the ESS. A maximum output is shown at a beginning phase and an initial phase of the electric vehicle charging, and the output of the charger is lowered over time, and when the termination of the electric vehicle charging is approached, the output may reach a lowest level. The contract power related to the grid is exemplarily expressed as a certain level, and hereinafter, the contract power will be described in more detail.

A graph of output B shows a grid output over time, and the maximum output is shown at the beginning phase and the initial phase of the electric vehicle charging, and the output of the charger is lowered over time, and when the termination of the electric vehicle charging is approached, the output may reach the lowest level.

A graph of output C shows an ESS output over time, and the maximum output is shown at the beginning phase and the initial phase of the electric vehicle charging, and the output of the charger is lowered over time, and when the termination of the electric vehicle charging is approached, the output may reach the lowest level. Here, the maximum output of the ESS is a value acquired by subtracting the contract power of the grid from the maximum output of the charger.

FIG. 1C is a conceptual configuration diagram of a system according to exemplary embodiments of the present disclosure.

The power is provided from the power grid for the electric vehicle charging, and supplied to the charger for the electric vehicle after AC/DC conversion. When the energy storage system (ESS) assists the power of the grid, and performs charging and discharging, a switching circuit is included in an AC/DC conversion unit, so it is possible to switch discharging and charging of the energy storage system during an electric vehicle charging procedure.

Therefore, exemplary embodiments of the present disclosure may provide a method for electric vehicle charging, in which a charging procedure is performed through the charger by receiving the power of at least one of the power grid and the energy storage system, and the discharging and the charging of the energy storage system are enabled to be switched according to the state of the power grid during the electric vehicle charging procedure.

Subsequently, a relationship between the output of the charger, and the output and the state-of-charge (SoC) of the ESS will be described in more detail.

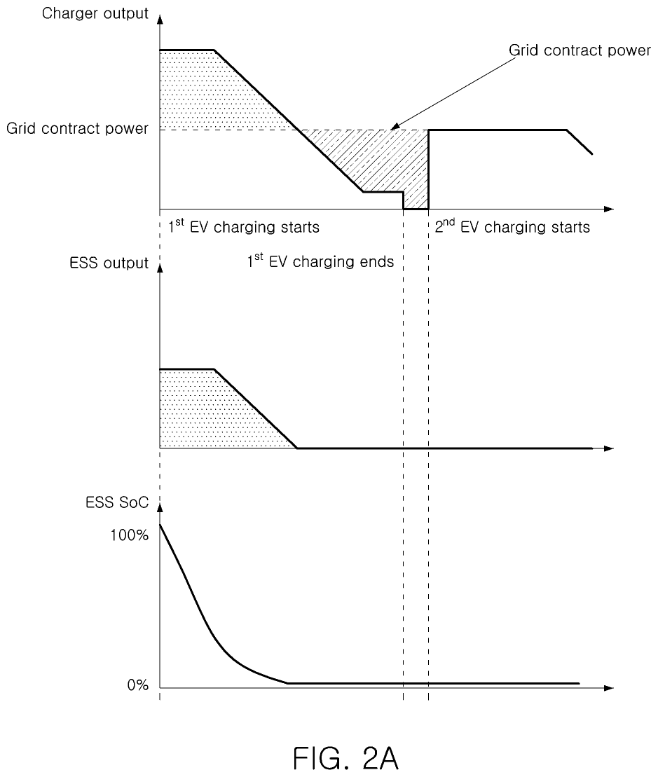

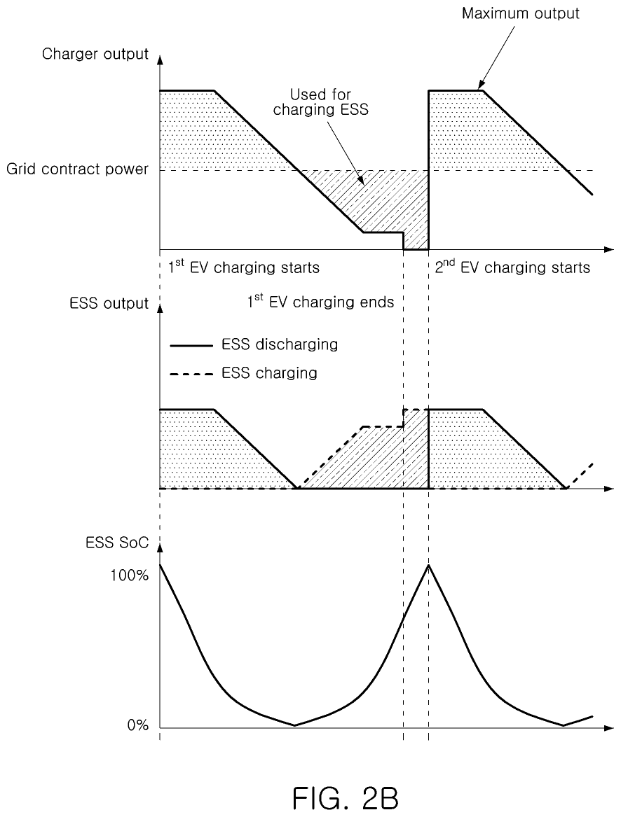

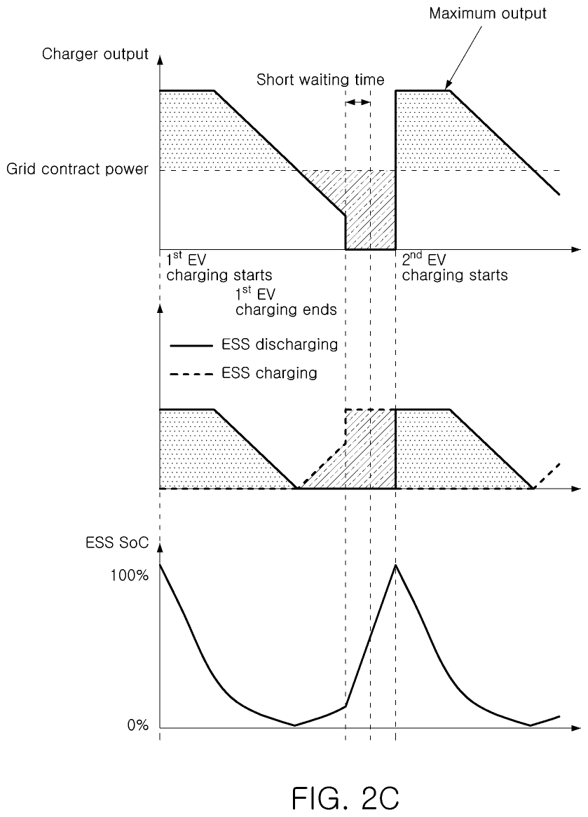

FIG. 2A is a conceptual diagram for the relationship between the output of the charger, the ESS output, and the state-of-charge (SoC) of the ESS according to a first exemplary embodiment of the present disclosure.

The description of FIGS. 1A and 1B pertain to a case where a charger output exceeding the contract power of the grid is required, for example, when starting the charging of a first electric vehicle. Thus, the electric vehicle is first charged with the ESS output. The output of the charger is lowered by continuous discharge of the ESS over time, and the charging is subsequently performed with the power of the grid, up to a charging termination time of the first EV during an interval of the grid contract power or less. Thereafter, charging of a second EV is intended to be immediately performed, the charging of the second EV may not be immediately used by the discharge of the ESS. That is, as can be seen from measurement of the SoC of the ESS, the SoC reaches a state of almost 0% at the first EV charging termination time.

When the EV charging is started in a state in which the ESS is fully charged, it is possible to charge the EV with the maximum output by assistance by the ESS. When a capacity of the ESS is similar to electric energy that assists the EV, it may be difficult to assist a second EV after charging one EV. The capacity of the ESS may be increased in order to solve this problem, but there is a problem in that overall cost is increased, and profitability is lowered. As another method, the ESS may be charged again, but there is a problem in that the number of charging EVs is reduced for a waiting time during recharging, and the profitability is lowered.

On the other hand, during the second half of the first EV charging, it can be seen that there is an area where the contract power of the grid is wasted. Therefore, the inventors of the present disclosure recognize a problem for the waste area, and research and develop a technical method capable of improving the problem.

FIG. 2B is a conceptual diagram for a relationship between the output of the charger, the ESS output, and the state-of-charge of the ESS according to additional exemplary embodiments of the present disclosure.

In order to describe the background, a lithium ion battery (LIB) used currently used for the electric vehicle is enabled to be rapidly charged in a low SoC due to low electrochemical characteristics, but when the SoC is raised up to a predetermined level or more, the lithium ion battery (LIB) is charged by lowering a speed of a safety reason. Even though the super fast (ultra-fast) charger is applied, super fast charging is performed only during an initial interval, and a low-speed charging mode is reached after a predetermined period, and there is a regret for an EV charging process. That is, the ESS assisting the power grid should preferably supply optimal power according to an electric energy required by the electric vehicle, and it can be seen that a vanadium ion battery (VIB) having a wide charging/discharging (C-rate) coverage (available range) is a battery optimized for the ESS.

Therefore, the present inventors have developed a charging system in which the ESS is simultaneously charged and discharged during the electric vehicle charging. That is, a system is devised, in which the ESS discharging occurs to assist the power of the power grid in the electric vehicle fast (or ultra-fast) charging interval, and then the ESS is charged according to the state of the power grid when entering the electric vehicle low-speed charging interval. Consequently, the system may be referred to as a system in which the difference between the SoC of the ESS when starting the electric vehicle charging and the SoC of the ESS after terminating the electric vehicle charging is less than or equal to a predetermined value.

Further, the present inventors have known that since a change in discharging/discharging output is large according to the state of the power grid, the VIB ESS is appropriate which is possible to respond to both the low output and the high output.

The present inventors propose that the system is to be used for charging the VIB ESS with respect to the area where the contract power of the grid is wasted illustrated in FIG. 2A.

Here, charging may be made with respect to at least one battery, at least one cell, at least one module, and/or at least one rack in the VIB ESS.

First, when the electric vehicle charging continuously occurs, if the charger output is lowered below a reference value, e.g., the contract power (of the power grid), a remaining surplus output may be used for charging the ESS. When a required control is performed herein, the SoC of the ESS is not changed until the second EV is charged after the first EV charging is terminated. That is, the present inventors have devised a charging system in which both the charging and the discharging of the ESS are performed during an electric vehicle charging process so as to supply the grid power to a specific building and also additionally charge the electric vehicle so that an EV user may continuously use a best-state charger.

Since a cycle of full charging and discharging per EV occurs in the ESS at this time, a VIB having a long lifespan is advantageous. Even though a charger operator uses an ESS having approximately half the capacity of one EV, the charger operator may also maintain a maximum charging speed.

FIG. 2C is a conceptual diagram for another relationship between the output of the charger, the ESS output, and the state-of-charge (SoC) of the ESS according to additional exemplary embodiments of the present disclosure.

When the electric vehicle charging is interrupted, some of the EV users may stop charging and operate the EV if the electric vehicle charging speed falls to a predetermined value or less. Therefore, there may be a need for securing some charging time of the ESS or also a need for lowering the maximum output to a predetermined level while securing the charging time of the ESS.

This is represented as an area of a short waiting time in FIG. 2C, and represents a relationship between the charger output, the ESS output, and the ESS SoC.

When the electric vehicle charging is terminated before a reference value for switching from the discharging to the charging of the ESS, a control of resuming super fast (or ultra-fast)charging is performed after securing the charging time of the ESS for a predetermined time.

Alternatively, when the electric vehicle charging is terminated and the super fast charging is immediately conducted before the reference value for switching from the discharging to the charging of the ESS is reached, a control of adjusting electric vehicle super fast charging power downward is performed. For example, the control may also be executed when it is difficult to discharge the ESS.

Further, exemplary embodiments of the present disclosure relate to a system for electric energy meter panel management, which judges and manages a power flow of an entire system in which an ESS is installed.

The present inventors recognize that there is a problem in a quality for power measurement by existing ESS related apparatuses. In particular, there is a problem in that a deviation is significant in measurement power of a power converter itself due to noise of power conversion units which are particularly required to be installed in the ESS and an EV charger. Therefore, the present inventors conceive a management system configuration and a management method of the electric energy meter panel, and are capable of immediately responding to an emergency situation of loads other than an ESS dedicated load. A monitoring network particularly implemented and constituted by various sensors which are capable of communicating with each other, electric energy meters, etc., is constructed in the electric energy meter panel management system, so AC or DC voltage, AC or DC current, a grid frequency, etc., are basically measured and selectively, a temperature, a humidity, etc., are additionally measured to manage and control electric energies of the entire region of the grid.

The electric energy meters constituting the monitoring network are capable of tracking noise causes in the grid, and may immediately judge the emergency situation and control solving the emergency situation. Therefore, involvement in bill settlement is also possible through judgment and management of power consumption and loss power.

Even though a failure or an abnormal operation occurs in some of a plurality of electric energy meters, it is possible to infer the electric energy, and it is possible to precisely track failure states of electric/electronic devices in the grid, so it may also be possible to manage the efficiency of the power conversion unit.

As an example, in relation to bill settlement in an existing ESS operating system, it may not be easy for a user to confirm an actual electric energy upon electric charging and using electricity. Therefore, in the ESS supplemented between the grid and the load (at the user side), the configuration and the management of the present disclosure are implemented to calculate a loss amount for each location (site).

For example, after calculating a power loss amount from the grid to the load, the ESS may supplement the corresponding loss amount, and a bill may be requested to a supply source as large as the supplemented electric energy amount. When the loss amount is calculated from the ESS to the load, a bill discount benefit may also be given upon settlement as large as the electric energy amount lost in the ESS. Here, a bill settlement screen may be shown to the user, and an ESS supplement loss power bill other than a total usage bill and a settlement price may also be displayed and announced.

If a power supplier autonomously judges a lost part and gives a discount, the user may expect that a company image and a company reliability are enhanced. Further, since the ESS should be installed and managed so that the loss is not generated in the power supplemented by ESS in order not to give a discount benefit as possible, it is also possible to expect ESS quality enhancement.

Next, features of the related art and the present disclosure are compared and described.

When a management scheme is considered, the related art and the present disclosure are different from each other in that the management scheme is ESS-based management in the related art, and the management scheme is management according to the power state of the grid in the present disclosure.

With respect to an operation control type, if a charging/discharging request for the ESS is received, an operation is performed, or if a frequency of the grid fluctuates, the operation is performed, or an operation through demand prediction is performed. On the contrary, the present disclosure and the related art may be different in that in the present disclosure, the operation is performed according to a power situation of the grid in which the ESS is installed, or an additional operation according to a usage amount and a loss amount for each interval, or an emergency operation is performed when an emergency situation occurs.

Therefore, emergency situation recognition is impossible as a problem in the related art, and the power is inefficiently used, and there is an increase in dependency on a specific device. As an example, when frequency sensing is used, there is a disadvantage in that frequency sensing depends only on a frequency measurement device or a demand prediction scheme depends only on existing data. However, in the present disclosure, in an overall system, more complicated and precise electric energy measurement devices than the related art need to be installed, but such problems and disadvantages may be overcome.

As a result, the inventors of the present disclosure research and develop an electric energy meter panel management system of the present disclosure in terms of controlling an entire power network in which the ESS is installed other than the power control only for the ESS like the existing ESSs.

Further, there is also an effect that electric energy transaction such as power auction, power price bidding, etc., may also be more efficiently performed by utilizing the present disclosure.

Meanwhile, the electric energy meter panel management system of the present disclosure is applicable to various power networks, electric grids, smart-grids, etc.

As one example, a micro-grid refers to a power network that integratedly manages distributed power sources and loads in a small limited region to autonomously produce, store, and consume the power. Further, artificial intelligence (AI) technology is applied to enable management efficiency enhancement and energy transaction. Unlike the smart-grid (SG), the micro-grid has a small application scale, and a power generation source and a demand source are configured in one grid.

The micro-grid is categorized into an independent type or a system link type based on an operation type. The independent type micro-grid alone supplies power to an independent power network which is not linked with a central power system. On the contrary, in the case of the system link type, by supplying from the central power system the power in normal times and by a single operation upon emergency such as black out, reliability is higher than the independent type micro-grid. Further, construction of a long-distance power transmission network may be minimized through energy self-sufficiency in the corresponding region, and small and medium-sized distributed resources are installed near a demand area, so it is also unnecessary to build a large-scale power plant.

A micro-grid solution capable of management of supplied resources, systematic analysis, and power quality management in organic link with the power system requires excellent scalability, fast and accurate data processing, acceptance of various communication protocols, and the like, and it is important to apply conversion technology stipulated in IEC 61850 which is an international standard for interoperability.

The present inventors conceive a configuration and an operation of a system for electric energy meter panel management, which judges and manages a power flow of an entire system in which an ESS is installed in order to consider various requirements and for technical conformity.

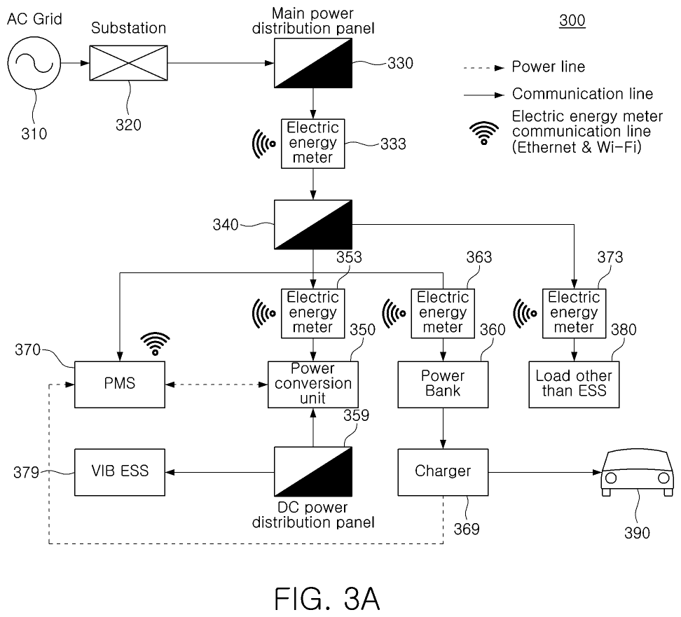

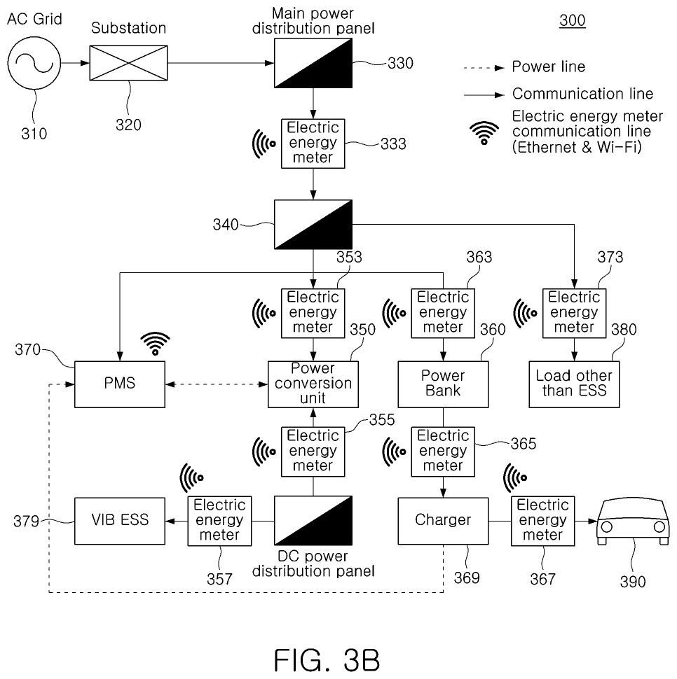

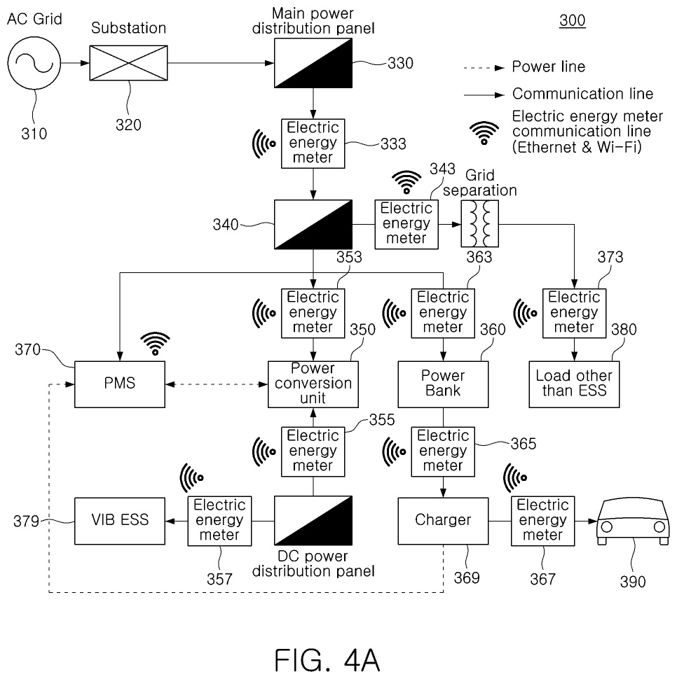

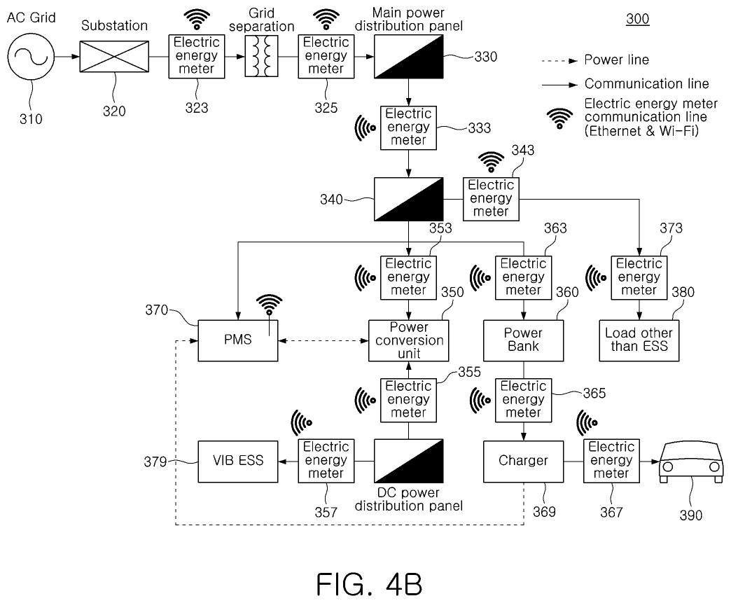

For more specific appreciation, features of additional exemplary embodiments of the present disclosure will be described in detail with reference to FIGS. 3A, 3B, 4A, and 4B.

For reference, all or most of the components illustrated in FIGS. 3A to 4B conceptually represent an entire system in which a specific region, i.e., the ESS is installed. Here, the system in which the ESS is installed may also be one building, and may mean a specific region or area to which the power should be supplied by both the power grid and the ESS in a form such as a commercial facility, a factory complex, etc., where various buildings are located.

A case where an overall electric energy meter panel management system 300 is applied to the ESS and an electric vehicle charger integrating system is exemplarily described, but the overall electric energy meter panel management system 300 is also applicable to a case where other types of ESS configurations and commercial application cases.

Further, the electric energy meters are exemplarily displayed in the drawing, but surveillance or monitoring means, devices, sensors, measurers, instruments, power meters, etc., may be used for confirmation, and comparison and judgment of various electric energies, and wired communication such as Ethernet or wireless communication equipment and technology such as wi-fi may be utilized for transmitting and receiving the electric energy information.

FIG. 3A is a diagram illustrating a configuration and an operation of a system for electric energy meter panel management, which judges and manages a power flow of an entire system in which an ESS is installed according to additional exemplary embodiments of the present disclosure.

Power provided by a power grid (e.g., an AC grid) 310 is subjected to required power conversion via a substation 320, and transferred to a main power distribution panel 330. The main power distribution panel 330 may be connected to at least one lower power distribution panel, and only an ESS power distribution panel 340 is exemplarily illustrated.

The ESS power distribution panel 340 may largely transfer ESS/charger power and power for a load other than the ESS through power distribution. A load other than the ESS 380 is diversified, and means electricity/power required for various mechanical facilities such as a lighting, a communication network including a server, a cooling/heating system, and an elevator of the corresponding building.

With respect to the ESS/charger power, there are a PMS 370 performing power management, and a power conversion unit 350 and/or a power bank 360 performing power conversion and processing. The PMS 370, the power conversion unit 350, and the power bank 360 are connected to each other electrically and communicationally.

A VIB ESS 379 including a vanadium ion battery (VIB) may be controlled by the PMS 370, and receive power from the power conversion unit 350 through a DC power distribution panel 359.

The power bank 360 transfers the power to a charger 369 to charge an electric vehicle 390. The charger 369 may be controlled by the PMS 370, and is also operatively connected to the VIB ESS 379.

Meanwhile, the PMS 370, the power conversion unit 350, the power bank 360, the VIB ESS 379, the charger 369, and the like are communicationally connectable to each other represented by dotted lines.

Additionally, the VIB ESS 379 may also supplement the power grid according to the situation, and discharge a battery charged with some power by the charger 369, the load other than the ESS 380, and the like and provide the power, and this is represented by small dotted lines. Thereafter, in FIGS. 3B, 4A, and 4B, it may be appreciated that the discharging of the VIB ESS 379, i.e., there is no power supply flow mark, but the corresponding operation may be performed.

In such a configuration, in order to judge and manage the power flow of the entire system in which the ESS is installed, a plurality of monitoring means, electric energy meters, etc., should be installed and operated an appropriate place in the electric energy meter panel management system.

For example, there is an electric energy meter 333 located between the main power distribution panel 330 and the ESS power distribution panel 340, and performing various measurements of electric energy, etc. The electric energy meter 333 measures total systematic consumption electric energy as compared with total available electric energy of the grid, and is used for extra electric energy, short electric energy, power disconnection information, etc.

There is an electric energy meter 383 located between the ESS power distribution panel 340 and the load other than the ESS 380, and performing various measurements of the electric energy, etc. The electric energy meter 383 measures total systematic power consumption as compared with the total available electric energy of the grid and a consumption amount of the load other than the ESS 380 (jointly with the electric energy meter 333), and is used for a load consumption amount, a power loss amount, extra electric energy, etc.

There is an electric energy meter 363 located between the ESS power distribution panel 340 and the power bank 360, and performing various measurements of the electric energy, etc. The electric energy meter 363 measures total systematic power consumption as compared with the total available electric energy of the grid and a consumption amount of the EV charger 369 (jointly with the electric energy meter 333), and is used for a load consumption amount, a power loss amount, extra electric energy, etc.

There is an electric energy meter 353 located between the ESS power distribution panel 340 and the power conversion unit 350, and performing various measurements of the electric energy, etc. The electric energy meter 353 and the electric energy meter 363 (i.e., as an electric energy meter around the power conversion unit) may judge an error for power conversion unit measurement. As an example, when it is judged that there is the error by comparing actual consumed power and power conversion unit's recognized consumed power with each other, it may also be determined that a failure occurs in the power conversion unit. Consequently, the electric energy meter is used for failure judgment, power conversion unit precision measurement, etc.

Meanwhile, when some electric energy meters have a failure, the grid state may also be judged based on data of electric energy meters which do not have the failure. That is, failed electric energy meter data may be obtained by aggregating of three load electric energies. For example, whether the electric energy meter 333 has the failure may also be found by using the electric energy meter 353, the electric energy meter 363, and the electric energy meter 383 jointly. As another example, whether the electric energy meter 383 has the failure may also be found by using the electric energy meter 353, the electric energy meter 363, and the electric energy meter 333 jointly. Consequently, the failed electric energy meter may be inferred and/or confirmed, and the grid control may be performed based on the data of the electric energy meter which does not have the failure.

Therefore, the plurality of electric energy meters (or monitoring means) forms one network to send and receive data in communication with each other like an Internet of things (IoT) network, a sensor network, etc.

Therefore, when the monitoring network is used, the following procedure may be performed in the case of a situation such as black out occurs in a system in which the ESS is installed. As a first step, the maximum electric energy which may be used in the grid in which the ESS is installed is confirmed or stored, as a second step, supply electric energy information on load other than the ESS is received, as a third step, charge's requested electric energy information is received, as a fourth step, electric energies in the second and third steps are compared and judged, and as a last step, when the power of the grid is cut off, the ESS supplements total grid power so that the power source of the facility connected to the grid is not cut off by performing discharging in the ESS.

Additionally, when the monitoring network is used, it is possible to cope with the failure or an abnormal situation anywhere in the system in which the ESS is installed. When output power is larger than supplied power or when the output power is even lower than the supplied power while charging, discharging, and waiting modes are driven, the VIB ESS 379 judges that the failure occurs, and in the case of electric vehicle charging, when the output power is higher than the supplied power, a system diagnosis requiring failure notification is generated. For example, when a sum of the grid power supplied to the charger 369 and the power supplied from the ESS 379 is smaller than the output power of the charger 369, it is judged that there is a failure situation.

Additionally, when the output power is remarkably lower than the supplied power, the system diagnosis required failure notification is generated. For example, when power of ((grid power supplied to charger 369+power supplied from ESS 379)×80%) is equal to or larger than the output power of the charger 369, it is judged that there is a failure situation.

FIG. 3B is a diagram illustrating a configuration and an operation of a system for electric energy meter panel management, which judges and manages a power flow of an entire system in which an ESS is installed according to additional exemplary embodiments of the present disclosure. Only other parts of FIG. 3A will be described, and basically, a structure in which electric energy meters are additionally applied to specific positions as compared with FIG. 3A is illustrated.

Upon actuating the power conversion unit such as the power conversion unit 350 and/or the power bank 360 (i.e., starting charging/discharging), a lot of errors of the electric energy autonomously judged may be one of reasons for a low power measurement quality, and an output of the power conversion unit may also be more accurately monitored by the electric energy meters.

To this end, the electric energy meter 355 located between the power conversion unit 350 and the DC power distribution panel 359, and performing various measurements of the electric energy, etc., and the electric energy meter 365 located between the power bank 360 and the charger 369, and performing various measurements of the electric energy, etc. may be installed and used. Consequently, it is possible to confirm an actually used electric energy, and it is also possible to measure noise generated in the power conversion unit.

When the electric energy meter 353 at a front end or at input side of the power conversion unit 350 and the electric energy meter 363 at the front end or at input side of the power bank 360 are additionally used jointly with both electric energy meters 355 and 365, precise measurements are possible such as more accurate efficiency measurement, power conversion unit efficiency information judgment, etc., at a front/rear end of the power conversion unit.

Further, additionally, the electric energy meter 367 located between the charger 369 and the electric vehicle 390, and performing various measurements of the electric energy, etc., and the electric energy meter 357 located between the DC power distribution panel 359 and the VIB ESS 379, and performing various measurements of the electric energy, etc. may be further installed and used. When the electric energy meters 367 and 357 are used jointly with two electric energy meters 355 and 365 described above, a power conversion unit output and power actually charged in the battery may be compared, and the comparison data is used for measuring the power loss amount, etc.

Meanwhile, when the battery management system (BMS) inside the VIB ESS 379 has the failure or the error, it is also possible to perform tasks such as estimation of the state of charge (SoC) of the battery, confirmation of battery voltage, etc., through the electric energy meter 355 between the power conversion unit 350 and the DC power distribution panel 359.

Additionally, when a difference of a total electric energy meter calculation value is severe, it is also possible to confirm a system error or a situation in which electricity is drawn and used without permission (electricity thief). As an example, in the electric energy meter panel management system of the present disclosure, when four electric energy meters 333, 355, 365, and 383 are jointly used, it is possible to manage the electric energy for the entire grid.

FIG. 4A is a diagram illustrating a configuration and an operation of a system for electric energy meter panel management, which judges and manages a power flow of an entire system in which an ESS is installed according to additional exemplary embodiments of the present disclosure.

Various measurement data of the electric energy meters of the monitoring network described above are described, and when it is judged that there is a lot of noise or an unstable power supply state, the electric energy meter panel management system of the present disclosure may also be designed so as to separate the grid.

As an example, in the power flow of the entire system in which the ESS is installed, when a lot of power noise is generated or predicted in the load other than the ESS, a grid separation device or structure may be installed or provided between the ESS power distribution panel 340 and the load other than the ESS 380. In this case, the electric energy meter 383 installed in the load other than the ESS 380 may be moved to the front end or at input side of the grid separation device, or another electric energy meter 343 may also be installed between the grid separation device and the ESS power distribution panel 340. Therefore, a source of the noise may be tracked in the entire system in which the ESS is installed, and also be separated or interrupted from the system as necessary.

FIG. 4B is a diagram illustrating a configuration and an operation of a system for electric energy meter panel management, which judges and manages a power flow of an entire system in which an ESS is installed according to additional exemplary embodiments of the present disclosure.

Although similar to FIG. 4A above, positions of the grid separation device and the additional electric energy meters are different. Still, by a more fundamental separation and interruption method than FIG. 4A, the grid separation device is placed between the substation 320 and the main power distribution panel 330.

Digital twin technology may also be used to construct the overall electric energy meter panel management system 300 illustrated in FIGS. 3A to 4B. The digital twin technology implements a product, equipment, a machine, a part, etc., of a real world in a virtual world in a computer, and may determine a problem which may occur through a simulation in advance, and solve the problem before making an actual product, equipment, etc. While a 3D design software program such as computer aided design (CAD) is used, and a vast amount of information may be collected through the Internet of things (IoT) technology, the accuracy of the digital twin is increased. When the digital twin technology is used, a state of the equipment, the system, etc., may be monitored, and improved by predicting and determining a maintenance time. Further, the safety may be verified by predicting various situations which may occur while managing the system, or an accident risk may also be reduced by preventing an unexpected situation, the failure, or an accident. Therefore, the digital twin technology may be used for installation positions, measurement items, specific functions, efficient management, etc., of the electric energy meters in the monitoring network of the present disclosure.

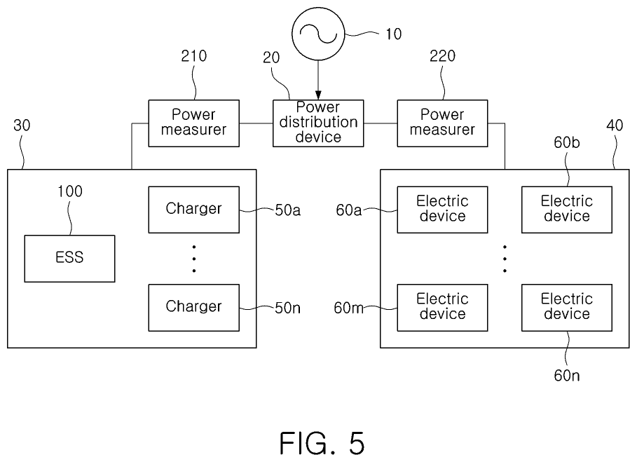

FIG. 5 is a conceptual diagram illustrating power supply configurations in which an energy storage system is disposed in a space and in which other electric devices are disposed according to an exemplary embodiment of the present disclosure. FIG. 5 illustrates the energy storage system (ESS) 100 and other electric devices that supply power to a supportive power region 30 and a primary power region 40. The grid corresponding to the power source 10 may supply the power to a supportive power region 30 and a primary power region 40. The grid corresponding to the power source 10 may supply the power to a supportive power region 30 and a primary power region 40. The energy storage system (ESS) 100 may be disposed in the supportive power region 30.

The power source 10 supplies the power to the corresponding space, and includes an AC grid as an exemplary embodiment. The power supplied by the power source 10 is distributed to two or more power regions 30 and 40 in a predetermined power distribution device 20.

As an exemplary embodiment, the power distribution device 20 may supply the power to the supportive power region 30 and the primary power region 40. The power distribution device 20 is a power distribution panel as an exemplary embodiment.

The primary power region 40 includes a region other than the supportive power region 30 among the regions to which the power source 10 supplies the power. The energy storage system according to an exemplary embodiment of the present disclosure may supply the power to the supportive power region 30 and the primary power region 40, and may be disposed in the supportive power region 30.

The energy storage system (ESS) 100 and one or more chargers 50a to 50n may be disposed in the supportive power region 30. Multiple electric devices 60a to 60n may be disposed in the primary power region 40. Further, a separate ESS distinguished from the energy storage system 100 disposed in the supportive power region 30 may be disposed in the primary power region 40. That is, a separate ESS distinguished from the energy storage system 100 may also be disposed in the electric device (e.g., 60 m) in the primary power region 40.

In the exemplary embodiment of FIG. 5, the power distribution device 20 may distribute the power to the supportive power region 30 and the primary power region 40. A configuration without the power distribution device 20 may also be included in the exemplary embodiment of the present disclosure, and in this case, the power supplied by the power source 10 may be provided to the supportive power region 30 and the primary power region 40 by one power line. Further, the energy storage system 100 and chargers 50a to 50n receiving some or all of the powers from the energy storage system 100 may be disposed in the supportive power region 30.

The energy storage system (ESS) 100 according to an exemplary embodiment of the present disclosure may supply the power to the supportive power region 30 and the primary power region 40 within a maximum supply range of the power supplied by the power source 10. The energy storage system 100 may charge or discharge according to an electricity demand or an expected demand used in two regions 30 and 40.

To this end, a power measurer 210 may be disposed in connection to the supportive power region 30. Alternatively, the power measurer 210 may be disposed inside the supportive power region 30.

Further, a power measurer 220 may be disposed in connection to the primary power region 40. Alternatively, the power measurer 220 may be disposed inside the primary power region 40.

The power measurers 210 and 220 which are electric level instruments (electric level meter) as an exemplary embodiment measure electric levels which are used in regions where the power measurers 210 and 220 are installed. The power measurers 210 and 220 transmit measured values (electric levels) to the energy storage system 100.

Further, according to an exemplary embodiment of the present disclosure, a separate power measurer may also be disposed in the power source 10. In this case, the energy storage system 100 may confirm a magnitude of consumed power of the power source 10 in real time.

According to another exemplary embodiment of the present disclosure, the energy storage system 100 aggregates consumption power of the power measurer 210 of the supportive power region 30 and consumption power of the power measurer 220 of the primary power region 40 branched from the power distribution device 20 to calculate a total electric energy consumed in the power source 10. This may vary depending on an implementation scheme, and the present disclosure is not limited thereto.

Further, the energy storage system 100 may include the power measurer 210 of the supportive power region 30 described above as a component. In addition, the energy storage system 100 may receive the power usage amount of the primary power region 40 from the power measurer 220 disposed in the primary power region 40 according to a predetermined communication protocol.

In this specification, the energy storage system includes an energy storage system including a vanadium ion battery, but the present disclosure is not limited thereto. For example, the energy storage system of the present disclosure may include a vanadium redox battery (VRB), a polysulfide bromide battery (PSB), zinc bromine battery (ZBB), or the like.

When the exemplary embodiment of FIG. 5 is applied, if the charger 50 charges the electric vehicle or another device which needs to be charged, the charger 50 may perform charging according to a charging condition required by the electric vehicle or other devices. For example, when high-current-rate charging is requested, the charger 50 performs the high-current-rate charging. The powers of the power source 10 and the energy storage system 100 are provided to the charger 50 according to the control of the energy storage system 100.

The energy storage system 100 may control the power to be supplied to the charger 50 from only the power source 10 according to the electric energy supplied by the power source 10 and the electric energy used by the primary power region 40. Further, the energy storage system 100 may control only the power of the energy storage system 100 to be supplied to the charger 50 according to the electric energy supplied by the power source 10 and the electric energy used by the primary power region 40. Alternatively, the energy storage system 100 may allow the power of the energy storage system 100 to be provided as some of power requested by the charger 50. As a result, the charger 50 may charge the electric vehicle or other devices with the powers supplied from both the power source 10 and the energy storage system 100.

The energy storage system 100 controls the electric energy to be provided to the charger 50 according to a power supply situation of the power source 10 or a power use situation of the primary power region 40, so the charger 50 may stably charge the electric vehicle or other devices even though the electric energy of the power source 10 is changed. In particular, when the charger 50 performs high current-rate charging, the energy storage system 100 supplies power at a predetermined level or more to the charger 50 according to the power supply situation of the power source 10 or the power use situation of the primary power region 40 to allow the charger 50 to stably perform the high current-rate charging.

In addition, when the charger 50 performs low current-rate charging, the charger 50 is supplied with the power from the power source 10 to charge the electric vehicle or other devices according to a power supply situation of the power source 10 or a power use situation of the primary power region 40 in the energy storage system 100.

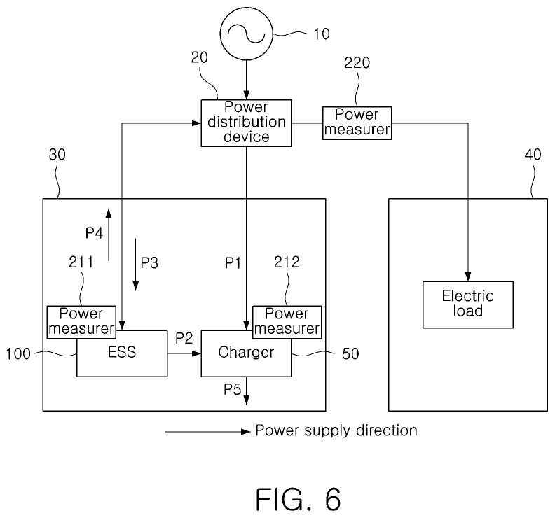

FIG. 6 is a diagram illustrating a configuration in which the charger receives power from the energy storage system 100 and a power distribution device 20 according to an exemplary embodiment of the present disclosure. The charger 50 may be supplied with the power from the power distribution device 20 and the energy storage system 100. More specifically, the energy storage system 100 may receive, from the power measurer 212, information on the electric energy used by the charger 50. The energy storage system 100 may receive, from the power measurer 220, information on the electric energy used by the primary power region 40.

In the exemplary embodiment of FIG. 6, the charger 50 may be supplied with the power from the power distribution device 20 (P1). An exemplary embodiment thereof is being supplied with the power from the grid, i.e., the power source 10. In addition, the energy storage system 100 compares information on the electric energies received from the power measurers 211, 212, and 220 and the maximum electric energy providable by the power source 10 to assist a part or the entirety of the electric energy to be used by the charger 50.

The energy storage system 100 may supply the power to the charger 50 (P2). The charger 50 may switch or merge the supplied power according to the control of the energy storage system 100. The charger 50 may supply the power according to a charging request of an external device (P5).

The energy storage system 100 may be supplied with the power from the power distribution device 20 (P3). In addition, the energy storage system 100 may supply the power to the primary power region 40 (P4). The power supplied by the energy storage system 100 may be supplied to the primary power region 40 via the power distribution device 20. That is, a power supply direction between the energy storage system 100 and the power distribution device 20 may be bidirectional.

The power supply of the energy storage system 100 (P4) may be determined by the power demand of the primary power region 40, the maximum electric energy which may be provided by the power source 10, etc.

Therefore, when the electric energy of the grid 10 measured by the power measurer 220 is less than or equal to a predetermined reference, the energy storage system 100 may perform high current-rate discharging so that the charger 50 performs the high current-rate charging. The energy storage system 100 continuously monitors the electric energy of the grid 10 in the process of performing the high current-rate discharging so that the charger 50 performs the high current rate charging.

As a result, the energy storage system 100 may stop the high current-rate discharging for the charger 50 when the power usage amount of the grid 10 increases. Alternatively, the energy storage system 100 may perform the high current-rate discharging to support the high current-rate charging of the charger 50 according to the autonomous energy storage situation.

When the energy storage system 100 supports fast (or ultra-fast) charging and discharging functions of the charger 50, the energy storage system 100 monitors the electric energy of the grid 10 to flexibly respond to the power situation of the grid 10. In particular, the energy storage system 100 may predict a time zone in which a power usage amount of the grid 10 is low by accumulatively storing information for a past power usage time of the grid 10. As a result, the energy storage system 100 may prepare for a case where power usage of the grid 10 is to be rapidly increased during fast charging and discharging processes of the charger 50.

Moreover, even when fast charging of the energy storage system 100 is required, such a process may be applied. That is, the energy storage system 100 may conduct the fast charging of the energy storage system 100 by being supplied with the power of the grid 10. Even in this process, it is possible to flexibly respond to the power situation of the grid 10 by monitoring the electric energy of the grid 10 described above.

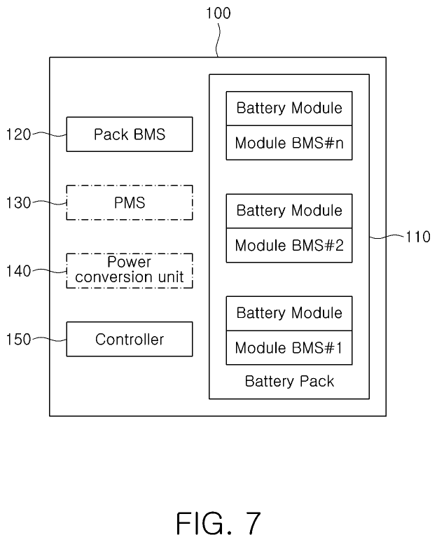

FIG. 7 is a diagram illustrating a configuration of the ESS according to an exemplary embodiment of the present disclosure. The energy storage system 100 includes an energy storage module 110 and a controller 150. The energy storage module 110 may include a battery.

The controller 150 may determine charging or discharging of the energy storage module by using an electric energy measurement result of the supportive power region and the electric energy measurement result of the primary power region. Further, the controller 150 may determine to discharge to at least one of at least one charger disposed in the supportive power region or the primary power region.

The energy storage system 100 includes a pack BMS 120 that manages charging and discharging of the energy storage module 110. Further, the energy storage system 100 may selectively include a power management system (PMS) 130 and a power conversion unit 140. When the energy storage system 100 includes both the PMS 130 and the power conversion unit 140, the energy storage system 100 may be referred to as an integrated ESS.

Alternatively, according to a configuration of the energy storage system 100, the PMS 130 and the power conversion unit 140 may be physically distinguished from the energy storage system 100, and configured as separate systems. The PMS 130 and the power conversion unit 140 may be independently managed as the separate systems, and exchange information through communication with the energy storage system 100 to control the operation of the energy storage system 100.

The energy storage module 110 of the energy storage system 100 may be constituted by one or more battery modules and module BMSs managing the battery modules as illustrated. An exemplary embodiment of the energy storage module 110 configures the battery module and the module BMS as one set, and includes a battery pack including one or more sets.

The battery of the energy storage module 110 may charge the electric vehicle via the power conversion unit 140. The power conversion unit 140 may receive the electricity and store the electricity in the battery, or emit the electricity to the system. In this process, the power conversion unit 140 may perform AC/DC conversion or convert a voltage, a frequency, or the like which is input/emitted.

The PMS 130 may exchange information with the power conversion unit 140 by using the communication, and provide information required for charging or discharging or control the battery to the power conversion unit 140.

A module BMS manages the battery by monitoring a charging state, a discharging state, a temperature, a voltage, a current, etc., of the battery. The pack BMS 120 is a battery management system for an entire battery pack.

The controller 150 may determine charging or discharging of the energy storage module 110 by using a power measurement result of the supportive power region and the power measurement result of the primary power region, or determine whether to discharge power to one or more chargers disposed in the supportive power region or the primary power region. Further, according to an exemplary embodiment, the controller 150 is integrated with the PMS 130 to operate as one component.

According to an exemplary embodiment of the present disclosure, the controller 150 may become an independent component. According to another exemplary embodiment of the present disclosure, the controller 150 may be implemented in the PMS 130, and the PMS 130 may provide a function of a controller to be described in this specification.

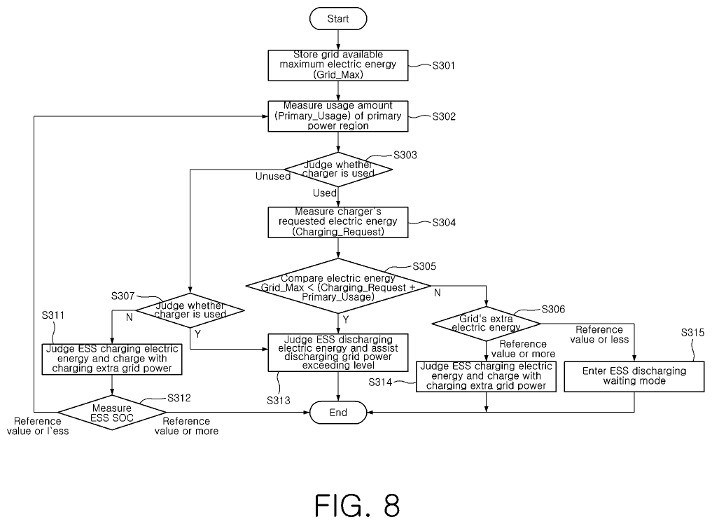

FIG. 8 is a diagram illustrating a process in which a controller controls the ESS according to electric energy in a grid according to an exemplary embodiment of the present disclosure.

The controller 150 may store a maximum electric energy Grid_Max of the grid for supplying the power to the primary power region and the supportive power region, i.e., the power source 10 (S301). The maximum electric energy Grid_Max means a maximum electric energy which may be used in the grid. In this case, the power source 10 described above may provide information on the maximum electric energy to the controller 150. Alternatively, the maximum electric energy of the power source 10 may be input into the controller 150 in advance. The maximum electric energy may increase or decrease according to the power supply situation afterwards, and the controller 150 may update information on the input maximum electric energy according to the increase or decrease of the maximum electric energy.

Thereafter, the power measurer 220 measures a power usage amount Primary_Usage of the primary power region 40 (S302). This measures the power usage amount (load usage amount) which is generated in a region other than the supportive power region 30 in which the energy storage system 100 is disposed, as an exemplary embodiment. In addition, the energy storage system 100 may receive the power usage amount (Primary_Usage) of the primary power region 40 from the power measurer 220 disposed in the primary power region 40 according to a predetermined communication protocol.

Further, according to another exemplary embodiment of the present disclosure, in step S302, the energy storage system 100 or the controller 150 may receive a total power consumption of the grid and the power usage amount of the primary power region. For example, a separate power measurer may be disposed between the power source 10 and the power distribution device 20 in FIG. 1 above. The controller 150 receives information on the total power consumption of the grid from the power measurer disposed between the power source 10 and the power distribution device 20 to monitor the power usage situation of the grid.

Next, the controller 150 judges whether the charger 50 disposed in the supportive power region 30 is used (S303). When there are multiple chargers 50, the controller 150 may judge whether each charger 50 is used. If the charger 50 is unused, the controller 150 proceeds to step S307. The controller 150 compares electric energies (S307), and compares Grid_Max and Primary_Usage, and when Grid_Max is greater than or equal to Primary_Usage, the controller 150 conducts charging by determining the ESS charging amount (S311).

In addition, the controller 150 measures a state of charge (SoC) of the ESS (S312), and terminates charging when the SoC is greater than or equal to a SoC reference value. Meanwhile, the controller 150 measures the SoC of the energy storage system 100 (S312) to control the charging of the ESS while repeating the process from S302 when the SoC is less than or equal to the SoC reference value.

Meanwhile, when Grid_Max is less than Primary_Usage in S307, the controller 150 judges a discharge electric energy of the energy storage system 100 to control the energy storage system 100 so that the energy storage system 100 discharges the power to the primary power region 40 (S313). As a result, a grid power exceeding level is assisted by the discharge of the energy storage system 100.

When the charger is being used in S303, the controller 150 measures a charger's requested electric energy Charging_Request (S304). In this case, it is assumed that the SoC of the ESS is greater than or equal to the reference value. In addition, the controller 150 compares the electric energies (S305), and compares Grid_Max with a sum (Charging_Request+Primary_Usage) of Charging_Request and Primary_Usage.

When Grid_Max is less than (Primary_Usage+Charging_Request) as a comparison result, the controller 150 judges the discharge electric energy of the energy storage system 100 to control the energy storage system 100 so that the energy storage system 100 discharges the power to the primary power region 40 (S313). As a result, the grid power exceeding level is assisted by the discharge of the energy storage system 100.

Further, when Grid_Max is greater than or equal to (Primary_Usage+Charging_Request) as the comparison result of S305, the controller 150 confirms whether a difference is greater than or equal to a grid extra reference value (S306). Here, the difference is an extra electric energy of the grid, as expressed in Equation 1.

Extra electric energy of grid=Grid_Max−(Primary_Usage+Charging_Request) [Equation 1]

When the extra electric energy of the grid is greater than or equal to the grid extra reference value, the electric energy is sufficient, so the controller 150 judges a charging electric energy of the energy storage system 100 to control the energy storage system 100 so that the energy storage system 100 conducts charging (S314). This means that the energy storage system 100 conducts charging with the grid electric energy which is sufficiently extra.

On the contrary, when the extra electric energy of the grid is less than the grid extra reference value, there is a high possibility that the power demands of the supportive power region 30 and the primary power region 40 will not be satisfied with the electric energy of the grid afterwards, so the controller 150 makes the energy storage system 100 to enter a discharge waiting mode (S315).

In FIG. 8, in the steps of charging the ESS (S311 and S314), the controller 150 may perform a high current charging process of the battery. In addition, the controller 150 continuously receives an electric energy measurement result of the primary power region, and when the extra power of the grid is lowered, the controller 150 may charge the battery with low current or control the ESS to enter the discharge waiting model as in S315. Of course, even in the discharge waiting mode, the controller 150 monitors a total power situation of the grid and the SoC of the battery to determine whether low-power charging or high-current charging of the battery is conducted.

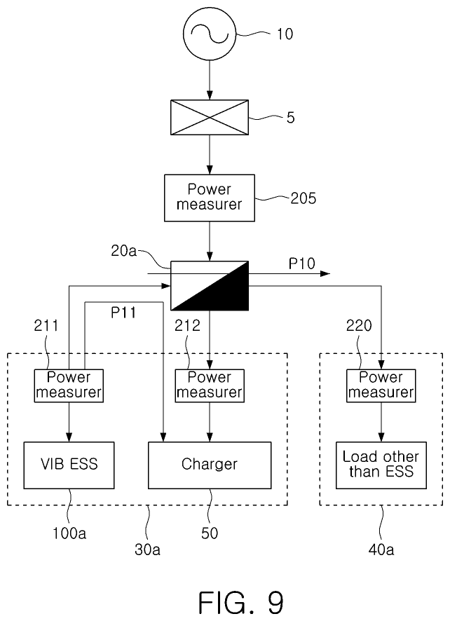

FIG. 9 is a diagram illustrating layouts and operations of the ESS and the charger according to an exemplary embodiment of the present disclosure. FIG. 9 illustrates a configuration in which a vanadium ion battery ESS (VIB ESS) 100a which is an exemplary embodiment of the ESS is disposed. A supply process of electricity is in an order of the power source 10 as the grid, a substation 5, a power measurer 205, and a power distribution device 20a which has the main power distribution panel as an exemplary embodiment, and the electricity is supplied from the power distribution device 20a to the VIB ESS 100a, the charger, 50, and the load other than the ESS. The power measurer 205 may be disposed in a grid's main power line, and the power measurers 211, 212, and 220 may be disposed even in respective regions 30a and 40a for each line. Information on power consumption for each region and all regions is transmitted to the VIB ESS 100a.

The supportive power region 30a and the primary power region 40a described above are partitioned. The usage amounts of the powers branched from the power distribution device 20a may be measured by the respective power measurers 211, 212, and 220. In addition, the controller disposed in the VIB ESS 100a may receive power consumption information measured by each power measurer. In this case, the VIB ESS 100a may include the PMS, and in this case, the PMS may provide the function of the controller.

As described in FIG. 8 above, the VIB ESS 100a stores information on the maximum electric energy Grid_Max which may be used by the grid. Further, the VIB ESS 100a may receive information on a supply electric energy (e.g., an electric energy being used in block 40a) of the load other than the ESS from the power measurer 220 disposed in primary power region 40a. Further, as an exemplary embodiment of the present disclosure, the VIB ESS 100a may receive the grid's total power consumption Grid_Usage from the power measurer 205.

As a reception scheme, either of periodic reception or real-time reception is available. In the periodic reception, the corresponding period may be changed according to a change in electric energy used in the primary power region 40a. For example, the controller 150 may set the reception period to 5 minutes at night when the change in electric energy is not almost changed, and set the reception period to 1 minute during the day when the change in electric energy is great.

The VIB ESS 100a may control charging or discharging of the VIB ESS 100a so as to optimize the power use of the grid according to the electric energy used in the primary power region 40a.

A driving mode of the VIB ESS 100a includes a charging mode, a discharging mode, and a waiting mode. In the case of the charging mode, the VIB ESS 100a determines an ESS charging amount, and conducts charging according to the SoC reference value of the ESS, and terminates the charging mode.

In the case of the discharging mode, the VIB ESS 100a receives requested electric energy information (Charging_Request) of the charger 50 from the power measurer 212. In addition, a sum of the electric energy (Primary_Usage) received from the power measurer 220 of the primary power region 40a and the requested electric energy information (Charging_Request) of the charger 50 is compared with Grid_Max to determine whether discharging is performed. A judgment process therefor is described in FIG. 7 above.

Further, when Primary_Usage is greater than or equal to Grid_Max or when the power of the grid is cut off, the VIB ESS 100a may discharge the charged electric energy to the primary power region 40a. For example, when the VIB ESS 100a discharges the electric energy to the power distribution device 20a as in P10, the power distribution device 20a may supply the power to the primary power region 40a.

Further, the VIB ESS 100a may also assist some or the entirety of the electric energy output by the charger 50 (P11). For example, when a value (available electric energy) acquired by subtracting the power usage amount of the primary power region 40a from the grid's maximum electric energy is smaller than the electric energy output by the charger 50 (i.e., a shortage level of the charging electric energy of the charger is generated), the VIB ESS 100a may assist an electric energy of the shortage level or an electric energy equal to or more than the shortage level.

In the discharging mode, the VIB ESS 100a may receive the grid's total power consumption from the power measurer 205.

For example, the VIB ESS 100a receives requested electric energy information (Charging_Request) of the charger 50 from the power measurer 212. In addition, the VIB ESS 100a receives information on the total power consumption (Grid_Usage) of the grid from the power measurer 205. In addition, a sum of the total power consumption (Grid_Usage) of the grid and the requested electric energy information (Charging_Request) of the charger 50 is compared with Grid_Max to determine whether discharging is performed. A judgment process therefor is described in FIG. 7 above.

Further, when Grid_Usage is equal to Grid_Max or Grid_Usage is greater than Grid_Max, so the power of the grid is cut off, the VIB ESS 100a may discharge the charged electric energy to the primary power region 40a. For example, when the VIB ESS 100a discharges the electric energy to the power distribution device 20a as in P10, the power distribution device 20a may supply the power to the primary power region 40a.

Further, the VIB ESS 100a may also assist some or the entirety of the electric energy output by the charger 50 (P11). For example, when a value (available electric energy) acquired by subtracting the grid's total power consumption Grid_Usage from the grid's maximum electric energy is smaller than the electric energy output by the charger 50 (i.e., a shortage level of the charging electric energy of the charger is generated), the VIB ESS 100a may assist an electric energy of the shortage level or an electric energy greater than or equal to the shortage level.

In the exemplary embodiment of FIG. 9, the VIB ESS 100a may maintain a waiting mode. When the SoC of the VIB ESS 100a is equal to or more than a reference value, the power usage amount in the grid may be monitored without a separate charging process. Meanwhile, when the SoC of the VIB ESS 100a is less than the reference value, charging may be conducted by determining the charging amount according to the current electric energy state of the grid. Of course, when the VIB ESS 100a is in the waiting mode, and the SOC is greater than or equal to the reference value, the VIB ESS 100a may supply the power to the primary power region 40a (P10) or supply the power to the charger 50 (P11) when the electric energy in the grid increases.

When the exemplary embodiment of FIG. 9 is applied, the VIB ESS 100a may optimize the electric energy of the grid according to the power use situation in the grid. For example, the VIB ESS 100a assists the electric energy to minimize loss due to excessive power or peak power and suppress grid overload.

Since the VIB ESS 100a supplies the power to the primary power region 40a and the charger 50 jointly with the grid in a predetermined situation, it is possible to stably supply the power. Further, the VIB ESS 100a calculates lost power by receiving the measurement value of the power consumption for each component to supplement the power supplying of the grid. For example, when the grid output is sensed as 100 or the charger-side output is sensed as 95, the VIB ESS 100a may supplement the power by 5.

The exemplary embodiment may be efficiently implemented in the case of the VIB ESS 100a. For example, a battery in which the heat generation and battery life-span are influenced upon the high output has a limit in supplementing the grid. On the contrary, the VIB is capable of performing a stable high output. Further, unlike the ESS constituted by a battery which may have a limitation in charging and discharging, the VIB ESS 100a is capable of performing input/output flow control by the high output, and may supplement both the grid and the charger with the high output when the black out of the grid occurs. In particular, the VIB ESS 100a is capable of performing the high output even in the case of instantaneous black out or power cut-off, so the system power may be stably supplied.

Further, the VIB ESS 100a is enabled to be charged at the high current rate (C-rate) when the power usage amount in the grid is low (i.e., when there is extra power) to enhance the use efficiency of the grid power.

Accordingly, the controller 150 of the VIB ESS 100a may receive the electric energy measurement result of the primary power region, and then determine any one charging scheme of the high-current charging or the low-current charging of the battery. The electric energy of the primary power region is compared with the grid's total usage amount, and when the electric energy of the primary power region is less than or equal to a predetermined reference (e.g., 80% or less), the VIB ESS 100a may be rapidly charged through the high-current charging.

On the contrary, when the electric energy of the primary power region is compared with the grid's total usage amount, and when the electric energy of the primary power region is greater than the predetermined reference (e.g., more than 80%), the VIB ESS 100a is continuously charged through the low-current charging to lower the entire load of the grid and assist the grid power by using power charged afterwards.

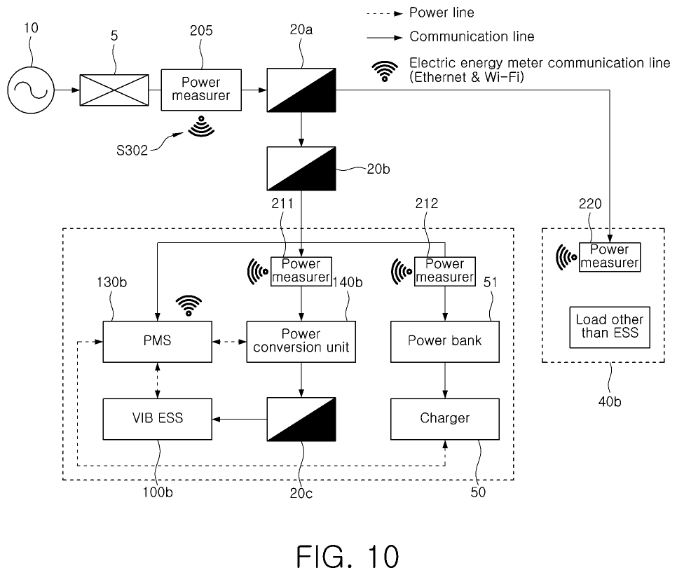

FIG. 10 is a diagram illustrating layouts and operations of the ESS and the charger according to another exemplary embodiment of the present disclosure. A configuration of FIG. 10 is an exemplary embodiment in which a power distribution device 20a serving as the main power distribution panel and the power distribution device 20b serving as an ESS power distribution panel are distinguished unlike FIG. 9. Moreover, the configuration of FIG. 10 is a configuration in which a power distribution device 20c serving as a DC power distribution panel (container) supplying the power to the VIB ESS 100b is separately disposed.

The power distribution device 20c may be configured to be divided into one or more elements, and the present disclosure is not limited to a specific configuration scheme of the power distribution device. The power distribution device 20c may be selectively disposed according to the configuration, the layout, and the like of the VIB ESS 100b.

In FIG. 10, the PMS 130b and the power conversion unit 140b are separately represented, but the present disclosure is not limited thereto, and the PMS 130b and the power conversion unit 140b may also be configured in the VIB ESS 100b. The PMS 130b is integrated with the controller 150 to control the driving mode such as the charging or the discharging of the VIB ESS 100b.

Further, a power bank 51 may also become a component of the charger 50 according to an implementation scheme of the present disclosure or an independent component from the charger 50. In the configuration of FIG. 9, the VIB ESS 100a may assist the total power of the grid. The VIB ESS 100b stores information on a maximum output amount of the power grid. In addition, the VIB ESS 100b may receive the grid's total power consumption from the power measurer 205. Alternatively, the VIB ESS 100b receives a measurement value of a usage amount of the load other than the ESS to judge a grid usable electric energy. The VIB ESS 100b receives information on the grid's total power consumption or receives the measurement value of the usage amount of the load other than the ESS to control the charging or the discharging of the VIB ESS 100b.

The load other than the ESS indicates a load for power use other than the VIB ESS 100b and the charger 50, and means a load in the primary power region 40b such as power use in a building, and power use in a home, a server, a subway, etc.

The information on the grid's maximum electric energy may be input into the VIB ESS 100b in advance, and when the grid's maximum electric energy is changed, the VIB ESS 100b stores a changed value. The input value may be stored in the ESS 100b, and maintained during a predetermined period. The VIB ESS 100b may store the information on the grid's maximum electric energy Grid_Max by a scheme such as 380 V AC/150 KW.

When the exemplary embodiment of FIG. 10 is applied, the grid such as the power source 10 supplies the power to the energy storage system 100b, the charger 50, and other loads (loads other than the ESS) other than the energy storage system and the charger. Further, the energy storage system 100b may include one or more power measurers 205, 211, 212, and 220 that measure the electric energies of the grid, the energy storage system 100b, the charger 50, and other loads (loads other than the ESS).

In addition, the controller of the energy storage system 100b may determine the charging or the discharging of the energy storage module by using any one or more of the electric energy of the grid or the electric energies of other loads measured by the power measurers 205, 211, 212, and 220, or determine to supply the power to the charger or other loads.

In the case of an exemplary embodiment in which the electric energy of the grid may be confirmed by the electric energies of other loads (loads other than the ESS), the energy storage system 100b may determine the charging or the discharging of the energy storage module by using the value measured by the power measurer 220 disposed in the load other than the ESS, or determine to supply the power to other loads.

Meanwhile, when the electric energy of the grid may not be confirmed by the electric energies of other loads, or it is necessary to confirm the electric energy of the grid in real time without an error, the energy storage system 100b may determine the charging or the discharging of the energy storage module by using the value measured by the power measurer 205 disposed in the power source 10, or determine to supply the power to the charger or other loads.

When the exemplary embodiment of the present disclosure is applied, when the power supplying of the grid is stable, the ESS charging may be conducted. On the contrary, when the power supplying of the grid is not stable, the ESS may supply the power to the primary power region 40b or the supportive power region 30b.

An energy storage system according to an exemplary embodiment of the present disclosure includes: an energy storage module including a battery, at least one power measurer measuring at least any one of electric energies of a grid, an energy storage system, a charger, and other loads, and a controller determining charging or discharging of the energy storage module by using at least any one of the electric energy of the grid or the electric energy of other loads measured by the power measurer, or determining to supply power to the charger or other loads.

A method for controlling an energy storage system according to an exemplary embodiment of the present disclosure includes: receiving, by a controller of the energy storage system, maximum outputtable electric energy information of a grid, measuring, by a power measurer of the energy storage system, at least any one of electric energies of the grid, the energy storage system, a charger, and other loads, and determining, by the controller, charging or discharging of the energy storage module by using at least any one of the electric energy of the grid or the electric energy of other loads measured by the power measurer, or determining to supply power to the charger or other loads.

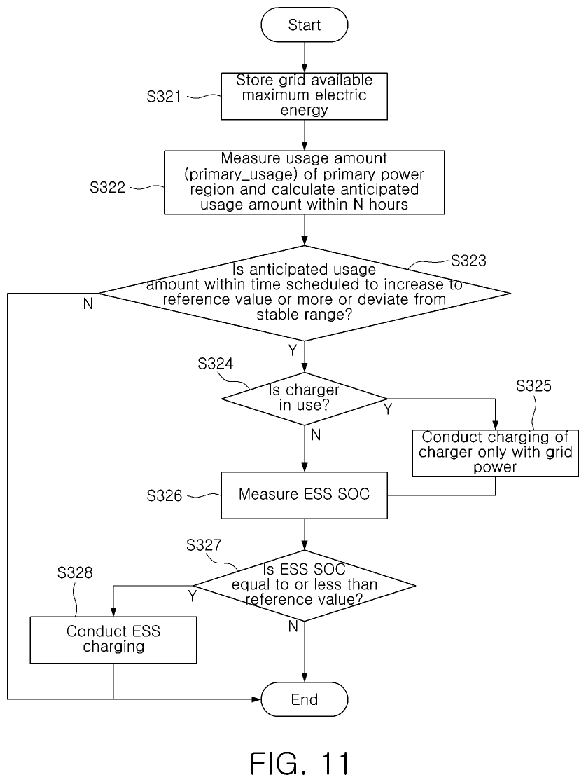

FIG. 11 is a diagram illustrating a process in which the ESS operates in response to a power use increase situation in the grid according to an exemplary embodiment of the present disclosure. The controller 150 may determine a discharging waiting mode for discharging to either one of the primary power region or the charger by calculating an anticipated usage amount of the electric energy of the primary power region.

The controller 150 stores the maximum electric energy Grid_Max usable by the grid (S321). In this case, the power source 10 may provide information on the maximum electric energy to the controller 150. Alternatively, the maximum electric energy of the power source 10 may be input into the controller 150 in advance.

Thereafter, the power measurer 220 measures a power usage amount Primary_Usage of the primary power region, and the controller 150 calculates an anticipated usage amount within N hours (S322). The controller 150 may accumulate and store information on the power usage amount Primary_Usage of the primary power region. The controller 150 monitors the power usage amount Primary_Usage of the primary power region in real time, and calculates the anticipated usage amount within N hours when the power usage amount increases.

In this case, the controller 150 may calculate the anticipated usage amount by reflecting seasonal factors. As an exemplary embodiment, the controller 150 may calculate the anticipated usage amount based on information (e.g., 2 p.m. to 4 p.m.) on a time zone for which an air conditioner is likely to be used in a corresponding space (the building, the home, etc.).

As a result, when the current power usage amount Primary_Usage of the primary power region belongs to a stable range or is less than or equal a reference value, the controller 150 may judge whether the anticipated usage amount within N hours departs from the stable range or is more than the reference value (S323). In this case, the controller 150 conducts the waiting mode to assist the power usage amount Primary_Usage of the primary power region by preparing for the increase in power usage amount.

The controller 150 confirms whether the charger 50 is in use (S324). When the charger 50 is in use, the controller 150 may control the charging to be conducted only with the grid power (S325). This is to conserve the power charged in the energy storage system 100 so as to assist the power use of the primary power region.

Further, when the charger 50 is not in use or the charger 50 conducts charging only with the grid power, the controller 150 measures the SoC of the energy storage system 100 (S326). When the SoC of the energy storage system 100 is less than or equal to a reference value according to the measurement result (S327), the energy storage system 100 conducts charging (S328).

When the process of FIG. 11 is applied, if the power usage amount Primary_Usage of the primary power region increases, the energy storage system 100 may assist the power.

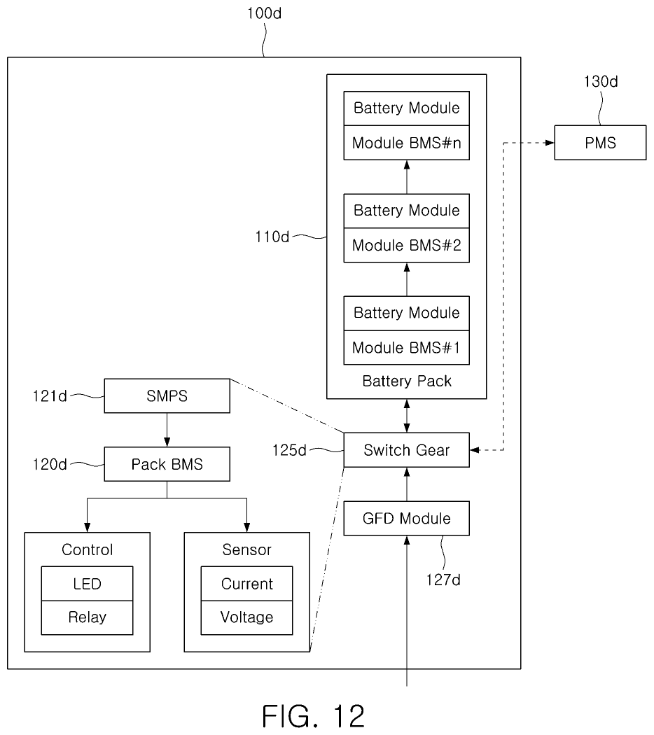

FIG. 12 is a diagram illustrating a configuration of the ESS according to another exemplary embodiment of the present disclosure. Power supplied from the outside is applied to a battery pack 110d via a ground fault device (GFD) 127d and a switch gear 125d. As a detailed configuration of the switch gear 125d, a switched-mode power supply (SMPS) 121d and a pack BMS 120d are used as an exemplary embodiment.

The pack BMS 120d may perform control and sensing, control an LED and a relay, and sense current and voltage.

In FIG. 12, the switch gear 125d and the PMS 130d may constitute the controller 150.

When the exemplary embodiment described above is applied, a power supply network includes two or more power supply sources including the power grid and at least one energy storage system.

The energy storage system (ESS) 100 receives a power charging request from the power charger 50 used for charging an object including a chargeable battery.

The energy storage system 100 compares a value acquired by aggregating the charger's requested electric energy 50 and an electric energy (Primary_Usage) defined for a primary use, and a maximum electric energy (Grid_Max) available from the power grid.

In addition, when the maximum electric energy (Grid_Max) available from the power grid is equal to or less than an aggregation value, the energy storage system 100 may perform a first procedure and if not, the energy storage system 100 may perform a second procedure.

In addition, the energy storage system 100 selectively performs the first procedure or the second procedure, so only the power grid, only the energy storage system 100 alone, or both the power grid and the energy storage system may provide the power to the power charger.

Here, the electric energy (Primary_Usage) defined for the primary use is related to power used in the primary power region 40 of the power grid. That is, the corresponding electric energy includes an electric energy of a load in a building.

As an exemplary embodiment in the first procedure, the energy storage system 100 performs judgment of a discharging electric energy of the energy storage system and performs discharging to supplement an electric energy exceeding the maximum electric energy (Grid_Max) available from the power grid.

As an exemplary embodiment of the second procedure, when the extra electric energy of the power grid is equal to or more than a reference value, the energy storage system 100 performs judgment of a charging electric energy of the energy storage system and performs charging, so the extra power of the power grid is used for charging and when the extra electric energy of the power grid is less than or equal to the reference value, the energy storage system 100 enters a discharging waiting mode.

The charger 50 supplies the power to the electric vehicle to charge the battery mounted on the electric vehicle. According to various power supply situations described above, the charger 50 may be supplied with the power from the grid (power source) 10 or the ESS 100. Alternatively, the charger 50 may be supplied with the power from both sides.

Meanwhile, billing for the provided power may vary depending on whether the charger 50 is supplied with the power from the power source 10 or whether the power is supplied from the charger 50. For example, a billing price per kwh when the charger 50 is supplied with the power from the power source 10 to charge the electric vehicle and a billing price per kwh when the charger 50 is supplied with the power from the charger 50 to charge the electric vehicle may be different. Besides, the billing price may vary depending on a charging time and the billing price may vary depending on a charging speed such as fast charging/slow charging.

Therefore, the charger 50 may change a billing system according to a source of power input into the charging, a charging speed, a charging scheme, charging time, and the like, and provide billing and charging interfaces so as for the user to easily confirm the changed billing system.

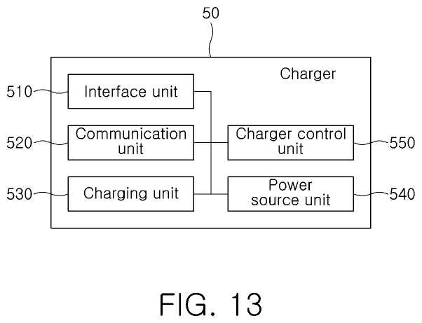

FIG. 13 is a diagram illustrating a configuration of the charger according to an exemplary embodiment of the present disclosure.

A charger control unit 550 controls an operation of the charger 50, and controls various components 510, 520, 530, and 540 constituting the charger 50.

An interface unit 510 provides an interface so that a user may input or confirm information in the process of charging various devices including the electric vehicle, an electric bicycle, etc., from the charger 50. The interface unit 510 may be constituted by a touch screen, a button, and the like.

The communication unit 520 transmits and receives information to and from external devices. The communication unit 520 may receive, from the ESS 100 or the PMS 130, a current available power situation, information on whether the input power is input from the grid or the ESS, and the like. Further, the communication unit 520 may transmit, to the ESS 100, the PMS 130, or the like, information related to a situation in which the charger 50 currently conducts charging. Alternatively, the communication unit 520 may transmit, to another charger, information related to a situation in which charging is currently conducted.

A charging unit 530 charges other devices (the electric vehicle, the electric bicycle, an electronic product, etc.). A power source unit 540 is supplied with the power from the outside and provides the power to the charging unit 530.

The charger control unit 550 outputs to the interface unit 510 a price, a time, an option, etc., which are related to the charging according to a source of the power supplied to the power source unit 540. The charger control unit 550 may control the charging unit 530 according to the source supplied to the power source unit 540, a charging option set by the interface unit 510, etc.

In summary, the power source unit 540 is supplied with the power from either one of the grid or the energy storage system. In addition, the interface unit 510 provides an interface capable of selecting any one scheme of a charging price scheme or a charging time scheme, and an interface for setting a charging price or a charging time according to the selected scheme.

The charger control unit 550 determines a billing unit of a charged price or a charging time according to the type of supply source. The charging unit 530 conducts charging according to the time or price selected by the interface unit 510.

Some or all of the features of the present disclosure may be utilized in a battery charging management system in which a used power use history is analyzed which is generated in a process in which a user performs charging in the ESS or an electric vehicle charging station to enable billing as large as actually charged power, and analyze a power use state and confirm power loss. According to the exemplary embodiment of the present disclosure, the battery charging management system described above may include a means for determining a use or consumption history for the power transmitted from the ESS, and analyzing information on energy use or loss. The power use information analysis means may solve a problem due to abnormality occurrence for the power transmitted from the ESS and a difference between actual used power and the transmitted power.

In order for an ESS operating system to conduct various controls so as to supply the power from the power grid to the battery of the ESS, various measurements, confirms, surveillances, and/or monitoring for the inside of the battery, the outside of the battery, a surrounding environment, and an entire system should be performed for each step (level). According to at least one exemplary embodiment of the present disclosure, the monitoring level may include four levels. Respective levels are connected by a network communication line, and serve to send and receive signals from each other, or issue or execute an instruction.

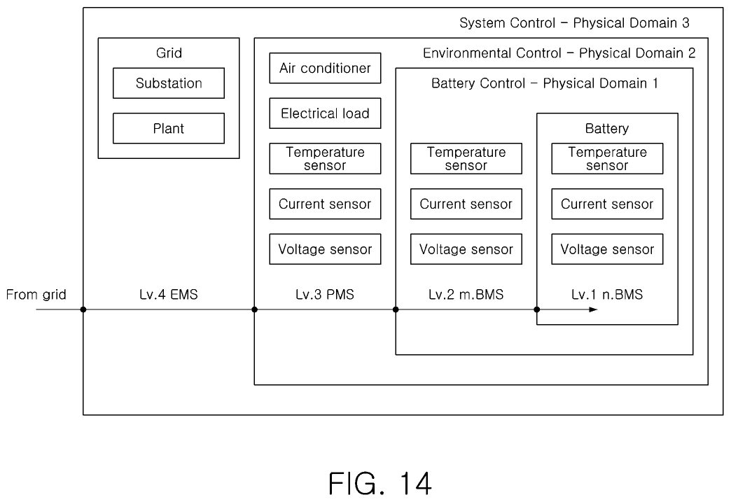

FIG. 14 illustrates an operation state management range when a monitoring level is constituted by Levels 1 to 4. FIG. 14 is provided an example in which some or all of the features of the present disclosure are applied to an ESS security management system.

According to at least one exemplary embodiment of the present disclosure, the monitoring level may include at least one of Level 1 including the BMS directly connected to the battery; Level 2 including Level 1 above and including a master BMS in which the BMSs of Level 1 are bundled and connected; Level 3 including Level 2 above and including a power management system (PMS) in which at least one of cooling and heating, the load, and the grid is controlled, and Level 4 including Level 3 above, and including a top-level energy management system (EMS) controlling at least one of the ESSs and the power systems in various regions. When the monitoring level is constituted by four steps, the monitoring may be specifically constituted by multiple levels as below.

Level 1 may generally mean a BMS directly attached to a battery called Slave BMS, Node BMS, or Module BMS; Level 2 may generally mean a composite BMS that bundles Level 1 BMS called Master BMS; Level 3 may mean a PMS in which cooling/heating, the load, the grid, and the like are controlled; and Level 4 may mean a top-level EMS controlling ESS, a power system, and the like in various regions.

Level 1 as a node battery management system (n.BMS) may measure a voltage, a current, and a temperature of the battery, and compare the measured voltage, current, and temperature with written values. Further, only an instruction (whether the balancing operation or external device control is performed) predetermined from the outside may be performed, and communication may transmit only the measurement value and an operation state of Level 1 to Level 2. If the error occurs inside, it is possible to conduct the emergency mode after outputting an error message, and in this case, the emergency mode may include inter-node switch cut-off, balancing cut-off, cooling fan actuation, etc. Further, an operation of reducing the charging amount of the battery by forcibly activating the balancing circuit may be performed in the emergency situation.

Level 2 as a master battery management system (m.BMS) may judge whether balancing is made based on battery data delivered from Level 1 above, and transmit an instruction signal to Level 1. Further, all voltages, currents, and temperatures may be accumulated and written, and delivered to the PMS of Level 3. Level 2 performs only the instruction (whether to perform the balancing operation) predetermined from the outside, and disregards other instructions to maintain the security. Further, when there is a significant difference between the battery data delivered from Level 1 and its own data (current, voltage, and temperature), an error signal may be transmitted. If the error occurs inside, the error message is output, and then the emergency mode is conducted, and in this case, the emergency mode may include inter-node switch cut-off, balancing cut-off, cooling fan actuation, etc. Further, the instruction may be given to Level 1 so as to forcibly perform the balancing operation in the emergency situation, and the SoC may be controlled.

Level 3 above as the PMS may perform a charging/discharging strategy based on the data delivered from Level 2 and its own measured data, and estimate the SoC of the battery and write the SoC. Further, it may be judged whether an electric load, an air conditioner (A/C), and the like are actuated. In addition, a charging/discharging current amount may be controlled according to a predetermined algorithm, and delivered to level 4. Level 3 may perform only the instruction predetermined from the outside, and other instructions are disregarded, so it is possible to maintain the security. When there is a difference between the autonomously measured data, and the current, voltage, and temperature delivered from Level 2, the error signal may be transmitted. If the error occurs inside, the error message is output, and then the emergency mode is conducted, and in this case, the emergency mode may include at least one of the inter-node switch cut-off, the balancing cut-off, the cooling fan actuation, charging/discharging operation stop, electric load using stop, and emergency safety switch actuation. Further, an operation of forcibly returning the current to the grid may be performed in order to reduce the SoC in the emergency situation.

Level 4 as the EMS may control the situation by monitoring the data delivered from Level 3 and a power situation of a power plant, and deliver information such as an expected usage amount to the power plant. Further, the power situation may be judged by communicating a current charging state, and expected temperature/usage amount data considering weather information, etc. may be delivered to the PMS. In addition, when usage amount limitation is instructed from the power plant, the instructed limitation may be delivered to the PMS. When there is a significant difference between the autonomously measured data, and the current, voltage, temperature, power usage amount, and the like delivered from Level 3, the error signal may be transmitted. Further, the emergency signal may be transmitted by sensing external invasion. In particular, Level 4 may have a system that monitors physical invasion or security threat through communication. Therefore, when the internal error is sensed, the error may be notified to a customer company or a management company. Besides, when the error occurs in the system due to natural disasters, accidents, or the like, level 4 may include an additional supplementary means so as to detect the error.

The battery charging management system of the ESS using four levels may include a power use information collection unit collecting power use information related to actual charging power and other power (e.g., heater power, BMS balancing power, V2L power, external leakage loss power, etc.), an information analysis unit distinguishing or analyzing the information collected by the power use information collection unit, and a charging execution unit to perform charging stop or charging state control based on such an analysis result, and perform battery charging management.

Further, some or all of the features of the present disclosure may be used, and applied to an electric energy supply method and a system thereof. More specifically, the present disclosure relates to an electric energy supply method that efficiently supplies the power to an electric energy storage or electric energy consumption region including the energy storage system (ESS) through the grid that is supplied with the electricity from the power supply source, and an electric energy supply device and an electric energy supply system using the same.

Further, in supplying the power from the grid and the ESS, information on power consumption and the remaining electric energy is collected and evaluated to efficiently control and manage charging/discharging of the ESS or supplying of electric energy from the grid, so the electric energy of the grid may be optimized, loss due to excessive power or peak power may be optimized and minimized, and grid overload may be suppressed. Further, since a complementary relationship between the grid and the ESS may be maintained, a high output is available in spite of a shortage of the total supply electric energy of the grid, a momentary power outage, and power cut-off, so there is an advantage in that system power is enabled to be stably demanded and supplied.

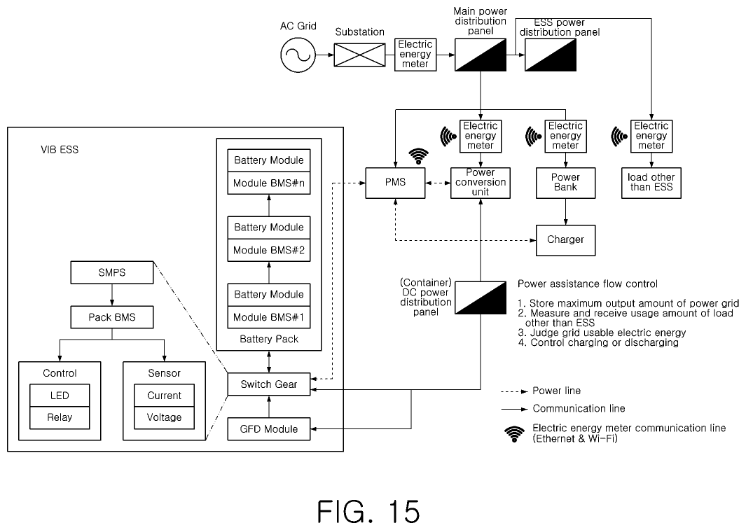

FIG. 15 exemplarily illustrates a system that supplies the power to the ESS and the power consumption region from the grid, controls information on consumable power obtained from the PMS of the ESS and power supplying to the power consumption region, and performs electric energy supplying including ESS charging/discharging management.

There may be provided an electric energy supply system that includes an ESS that is supplied with the power through the grid and performs charging/discharging, a charger that is supplied with the power from a power source of at least one of the ESS or the grid, and an auxiliary facility that is supplied with the power of the load other than the ESS, and includes a step of storing maximum outputtable power outputtable from the grid; a step of measuring or receiving the use electric energy of the load other than the ESS of the auxiliary facility; a step of measuring the use electric energy of the grid; and a step of controlling the charging or discharging of the ESS based on the power information collected in each step.

Further, an energy storage system electrically connected to a grid supplying power to an energy storage system, a charger, and other loads other than the energy storage system and the charger may be implemented, which includes an energy storage module including a battery; at least one power measurer measuring at least one of electric energies of the grid, the energy storage system, the charger, and other loads; and a controller determining charging or discharging of the energy storage module by using at least one of the electric energy of the grid or the electric energy of other loads measured by the power measurer, or determining to supply the power to the charger or other loads.

According to the electric energy supply method and the electric energy supply system, it is possible to supply energy very efficiently and provide the power stably in supplying and managing the electric energy, and it is possible to effectively respond to stable power supplying with respect to a power consumption unit such as the charger or an auxiliary facility which is a power consumption area by using the ESS even upon black out or power cut-off. The action effect may be a completely new electric supply process that may be predicted or estimated in the existing electric energy supply system.

As such, the present disclosure may show more various and excellent effects than the related art. According to the present disclosure, for example, since a used electric energy of the load is received and supplied as a typical effect, it is possible to reduce the load of the systematic power, and when extra power remains, charging is possible at the high C-rate, thereby remarkably enhancing the efficiency. Further, the present disclosure has an advantage in that since the high output is possible even in an instantaneous black out or power cut-off phenomenon, the systematic power may be stably maintained, and it is possible to judge whether the entire system on which the ESS is mounted has the failure. Accordingly, according to the present disclosure, the electric energy of the grid may be optimized, and loss due to excessive power or peak power may be optimized and minimized, and grid overload may be suppressed.

Further, since the powers of the grid and the ESS are jointly supplied to the load, it is possible to supply the power stably, and since power consumption for each component may be measured, lost power may be supplemented. For example, when a grid output is sensed as 100, but the charger output is sensed as 95, it is possible to manage the power very efficiently by a scheme in which the ESS supplements the power as large as 5. In particular, in the present disclosure, it is more excellent when vanadium ion battery (VIB) is used in the ESS.

For example, an LIB emits heat and influences a battery life-span upon high output, but the vanadium ion battery (VIB) is capable of stable high output. Further, the LIB has a limit such as 1C charging and 1C discharging, but the VIB is capable of input/output flow control with the high output, and for example, when the power outage of the grid occurs, the ESS using the VIB is capable of assisting both the grid and the charger with the high output, so in particular, in the case of the ESS adopting the VIB, ESS charging/discharging management is very efficiently possible. In particular, since there is no fire risk due to overload in the case of the VIB, when the VIB is applied to the ESS of the present disclosure, the ESS may be a very effective power supply system in that the electric energy supply system of the present disclosure may be preferably applied while guaranteeing a safety in various auxiliary facilities. Further, since it is possible to supply energy safely and efficiently in the present disclosure, the present disclosure may be utilized as an energy supply means that is very effective, safe, and eco-friendly in energy saving, or energy environment, realization of carbon neutrality, etc.

Additionally, by utilizing some or all of the features of the present disclosure, a high C-rate output and cell balancing control according to the output may also be performed.

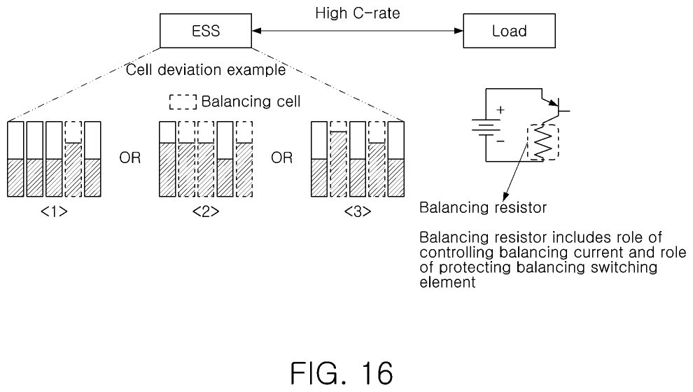

FIG. 16 is a conceptual view illustrating cases 1, 2, and 3 in which charging/discharging of the ESS is made at high C-rate with respect to a specific load, and which exemplarily illustrate various cell deviations with respect to internal battery cells of the ESS.

The present inventors recognize a problem in that a cell deviation occurrence probability and a deviation voltage increase upon high C-rate charging/discharging. As a solving method, a balancing current amount may be controlled by pulse width modulation (PWM), and the balancing current amount may be controlled by a scheme such as balancing with a maximum current amount at the high C-rate and balancing with a minimum current amount at a low C-rate.

As a result, since the balancing current is fluidly controlled, it is possible to stably maintain the high C-rate. For example, when cells in which cell deviations are generated are many, the PWM may also be controlled so as to achieve more balancing with respect to a specific cell.

A specific balancing scheme may be variously applied, and is not limited, and it is fundamentally important to fluidly control the balancing current. Further, since a resistance value of a balancing current limiting element may protect a balancing switch element, the resistance value may be lowered maximally, and the balancing current may also be controlled through current control through the PWM control.

Further, the present inventors also recognize a problem in that there may be a concern about stopping a cell monitoring BMS operation when the number of cells excessively discharged increases upon high C-rate charging/discharging.

When high-output discharge is performed when a battery power source is used as in an existing configuration or the related art, a stable operation is impossible due to input power variation of the BMS. That is, when the power supplying of the BMS is interrupted, the ESS power is generally interrupted, so there are many difficulties upon the high-output discharge. Further, when an external power source is used as in the existing/related art, there is a problem in that there is a rise in unit price due to addition of parts such as multiple connector wires, addition of a manufacturing process required therefor, and overall cost addition.

As the solving method, it is considered that when only lowest voltage is input, a boosting circuit may be configured so that the BMS may normally operate. Battery voltage is primarily input, and the input voltage is changed (boosted) to voltage so as for the BMS to operate, and provided as a BMS power input.

As a result, even when the deviation of the battery is generated, the BMS is enabled to stably operate, and even when multiple excessive discharge batteries are generated, the BMS is enabled to stably operate, and since only a minor number of elements are added to an internal circuit board of the BMS, the exemplary embodiment is enabled to be implemented without unit price rise minimization and particular process addition.

The present disclosure provides an energy storage system (ESS) management method in which in a battery management system (BMS) connected to a power grid and including an energy storage system (ESS), a control is performed so as to prevent a power source of a facility or equipment connected to the power grid from being interrupted by controlling an input/output of the ESS based on an electric energy of the power grid or so as for the ESS to cope with a total power situation of the power grid by sensing an abnormal operation.

In the ESS, an available power of the power grid and power used in other loads are confirmed by viewing a used electric energy to charge the ESS with extra power.

The controlling of the output of the ESS based on the electric energy of the power grid includes a step of monitoring a total electric energy of the power grid; and a step of confirming all of the electric energy used in the power grid, an electric energy required in an electric vehicle which is requested to be charged by using the BMS, or the electric energy used in a load of other areas connected to the power grid.

The performing of the control so as to cope with the total power situation of the power grid by the energy storage system (ESS) includes a discharging mode of judging all of the electric energy used in the power grid in which the ESS is installed, the electric energy used in the load other than the ESS, and the electric energy required for the electric vehicle charger to supplement the power of the power grid by performing preparation for a charging or discharging waiting state of the ESS with extra power of the power grid when all judged electric energies are less than a maximum electric energy of the power grid.

The sensing of the abnormal operation is performed by using at least one electric energy meter installed at an appropriate position of the battery management system (BMS).

The performing of the control so as to cope with the total power situation of the power grid by the energy storage system (ESS) includes a failure mode of judging all of the maximum electric energy used in the power grid in which the ESS is installed, the electric energy used in the load other than the ESS, and the electric energy required for the electric vehicle charger to perform a step of supplementing an excessive electric energy of the power grid in the ESS and sense power leakage, malfunction, or diagnosis necessity in advance and give a warning when all judged electric energies are more than the power of the power grid.

In the failure mode, when the output power is higher than the supplied power, or when the output power is remarkably lower than the supplied power, a system diagnosis required failure notification generation is performed.

Further, the present disclosure provides an energy storage system (ESS) management method which in a battery charging management system including an energy storage system (ESS), includes: a step of confirming all of a first electric energy used in a power grid, a second electric energy required for a charger used in electric vehicle charging, and a third electric energy used in a load of other areas connected to the power grid; and a step of selectively performing a charging/discharging mode for supplement the power of the power grid or a diagnosis mode of sensing a diagnosis necessity and giving a warning according to a confirmation result of the electric energies.

In the discharging mode, when a sum of the first electric energy, the second electric energy, and the third electric energy is less than a maximum electric energy of the power grid, the power of the power grid is supplemented by entering a charging or discharging waiting state of the ESS with extra power of the power grid.

An energy storage system (ESS) management method may also be performed in which in the diagnosis mode, when a situation occurs, in which grid power supplied to charger+power supplied from ESS<charger output power, or ((grid power supplied to charger+power supplied from ESS)×predetermined level %)>=charger output power, a procedure of generating a diagnosis notification is performed by judging that the battery charging management system needs to be diagnosed. Here, a predetermined level of percentage (%) may be exemplarily determined and compared with the charger output power. The predetermined level may also be determined as a range of 70 to 90% other than a specific numerical value.

In the ESS, at least one vanadium ion battery (VIB) is provided, and an available power of the power grid and power used in other loads are all confirmed by viewing a used electric energy to charge the ESS with the extra power.

In addition, the present disclosure provides an energy storage system (ESS) management system in a battery management system (BMS)connected to a power grid, which includes: a power conversion unit receiving and converting power from the power grid; an energy storage system (ESS) connected to the power grid and the power conversion unit; and a sensor network implemented to perform power flow judgment and management of an entire system in which the energy storage system (ESS) is installed.

The sensor network is connected and configured to measure all of an electric energy used in the power grid, an electric energy required in an electric vehicle requested to be charged by using the BMS, and an electric energy used in a load of other areas connected to the power grid.

At least one sensor of the sensor network is located at a front end or at input side of the power conversion unit, and in the ESS, an available power of the power grid and power used in other loads are all confirmed by viewing a used electric energy to charge the ESS with the extra power.

At least one power distribution panel for power distribution is located between the power grid and the power conversion unit, and at least one sensor is located at the front end or at input side of the power distribution panel.

When a specific sensor of the sensor network is not actuated, a function of the specific sensor may be replaced by using measurement results of other sensors of the sensor network.

The system management using the sensor network is implemented to perform at least one of an operation according to a power situation of a grid in which the energy storage system (ESS) is installed, an additional operation according to a power usage amount and a power loss amount for each interval, and an emergency operation when an emergency situation occurs.

The energy storage system (ESS) is a VIB ESS including a vanadium ion battery (VIB), and when an error or a failure occurs in the BMS, a state of charge (SoC) of the vanadium ion battery (VIB) is instead measured by using at least one sensor of the sensor network.

The energy storage system (ESS) is implemented jointly with an electric vehicle charger.

The entire system in which the energy storage system (ESS) is installed further includes a load other than the ESS, and it is judged whether the energy storage system (ESS) supplements the power grid and discharge the power to the electric vehicle charger according to measurement by the sensor network for the load other than the ESS.

A grid separation device is installed at a place where it is judged or predicted that power providing related noise is a lot or unstable according to measurement data of the sensor network.

Even though it is described that all components constituting the exemplary embodiment of the present disclosure are combined into one or operate in combination with each other, the present disclosure is not particularly limited to the exemplary embodiment, and one or more of all components may be selectively combined and operated within a purpose scope of the present disclosure. Further, each of all components may be implemented as one independent hardware, but some or all of respective components are selectively combined to be implemented as a computer program having a program module performing some or all functions combined in one or a plurality of hardware. Codes and code segments constituting the computer program will be able to be easily inferred by those skilled in the art of the present disclosure. The computer program is stored in computer readable media, and read and executed by a computer to implement the exemplary embodiment of the present disclosure. The storage media of the computer program include a magnetic recording medium, an optical recording medium, and a storage medium including a semiconductor recording element. Further, the computer program for implementing the exemplary embodiment of the present disclosure includes a program module transmitted through an external device in real time.

It is to be understood that the above-described embodiments are to be considered in all respects as illustrative and not restrictive, the scope of the present disclosure being indicated by the appended claims rather than by the foregoing detailed description. In addition, it should be construed that all changes and modifications that are derived from the meanings and ranges of the claims and concepts equivalents thereto are included within the scope of the present disclosure.

What is claimed is:

1. An energy storage system (ESS) management method comprising:
in a battery management system (BMS) connected to a power grid and including an energy storage system (ESS),
performing a control to prevent interruption of a power source of a facility or equipment connected to the power grid by controlling an input/output of the ESS based on an electric energy of the power grid; or
performing a control to allow the ESS to cope with an overall power situation of the power grid upon sensing any abnormal operations by controlling an input/output of the ESS based on an electric energy of the power grid.

2. The energy storage system (ESS) management method according to claim 1, wherein, in the ESS, an available power of the power grid is used to charge the ESS or extra power that remains after verifying power usage in other loads is used to charge the ESS-power.

3. The energy storage system (ESS) management method according to claim 1,
wherein the controlling of the output of the ESS based on an electric energy amount of the power grid comprises:
monitoring a total electric energy of the power grid; and
confirming at least one among an electric energy used in the power grid, an electric energy required in an electric vehicle requesting to be charged by using the BMS, and an electric energy used in a load of other areas connected to the power grid.

4. The energy storage system (ESS) management method according to claim 1,
wherein the performing the control so as to cope with the overall power situation of the power grid by the energy storage system (ESS) comprises a discharging mode in which:
an electric energy used in the power grid in which the ESS is installed,
an electric energy used in a load other than the ESS, and
an electric energy required for an electric vehicle charger to supplement the power of the power grid are all determined, and when all measured electric energies are found to be less than a maximum electric energy of the power grid, any surplus power from the power grid is used for charging the ESS or the ESS is prepared to be placed in a discharge stand-by state in order to supplement a power of the power grid.

5. The energy storage system (ESS) management method according to claim 1, wherein the sensing of the abnormal operation is performed by using at least one electric energy meter installed at an appropriate position of the battery management system (BMS).

6. The energy storage system (ESS) management method according to claim 1,
wherein the performing the control so as to cope with the overall power situation of the power grid by the energy storage system (ESS) comprises a failure mode in which:
an electric energy used in the power grid in which the ESS is installed,
an electric energy used in a load other than the ESS, and
an electric energy required for an electric vehicle charger are all determined, and when all measured electric energies are found to exceed a power of the power grid, any surplus power from the power grid is used for performing power supplementing at the ESS, and any power leakage, malfunctions or diagnostic needs are detected in advance and warnings are provided thereof.

7. The energy storage system (ESS) management method according to claim 6, wherein, in the failure mode, when the output power is higher than the supplied power, or when the output power is remarkably lower than the supplied power, a system diagnosis required failure notification generation is performed.

8. An energy storage system (ESS) management method comprising:
in a battery charging management system including an energy storage system (ESS),
a step of confirming a first electric energy used in a power grid, a second electric energy required for a charger used in electric vehicle charging, and a third electric energy used in a load of other areas connected to the power grid; and
selectively performing a charging/discharging mode for supplement the power of the power grid or a diagnosis mode of sensing a diagnosis necessity and giving a warning according to a confirmation result of the electric energies.

9. The energy storage system (ESS) management method according to claim 8, wherein in the discharging mode, when a sum of the first electric energy, the second electric energy, and the third electric energy is less than a maximum electric energy of the power grid, the power of the power grid is supplemented by entering a charging or discharging waiting state of the ESS by using any extra power of the power grid.

10. The energy storage system (ESS) management method according to claim 8, wherein in the diagnosis mode, when a situation occurs, in which (grid power supplied to charger+power supplied from ESS)<charger output power, or in which ((grid power supplied to charger+power supplied from ESS)×predetermined level %)>=charger output power, a procedure of generating a diagnosis notification is performed by judging that the battery charging management system needs to be diagnosed.

11. The energy storage system (ESS) management method according to claim 8, wherein in the ESS, at least one vanadium ion battery (VIB) is provided, and an available power of the power grid and power used in other loads are all confirmed by checking a used electric energy to charge the ESS with extra power.

12. An energy storage system (ESS) management system comprising:
in a battery management system (BMS) connected to a power grid,
a power conversion unit receiving and converting power from the power grid;
an energy storage system (ESS) connected to the power grid and the power conversion unit; and
a sensor network implemented to perform power flow judgment and management of an entire system in which the energy storage system (ESS) is installed.

13. The energy storage system (ESS) management system according to claim 12, wherein the sensor network is configured to measure each of an electric energy used in the power grid, an electric energy required in an electric vehicle requested to be charged by using the BMS, and an electric energy used in a load of other areas connected to the power grid.

14. The energy storage system (ESS) management system according to claim 13,
wherein at least one sensor of the sensor network is located at a front end or at input side of the power conversion unit, and
wherein, in the ESS, an available power of the power grid and power used in other loads are all confirmed by viewing a used electric energy to charge the ESS with extra power.

15. The energy storage system (ESS) management system according to claim 14,
wherein at least one power distribution panel for power distribution is located between the power grid and the power conversion unit, and
wherein at least one sensor is located at a front end or at input side of the power distribution panel.

16. The energy storage system (ESS) management system according to claim 15,
wherein, when a specific sensor of the sensor network is not actuated, a function of the specific sensor is replaced by using measurement results of other sensors of the sensor network.

17. The energy storage system (ESS) management system according to claim 12, wherein system management using the sensor network is implemented to perform at least one of
an operation according to a power situation of the grid in which the energy storage system (ESS) is installed,
an additional operation according to a power usage amount and a power loss amount for each interval, and
an emergency operation when an emergency situation occurs.

18. The energy storage system (ESS) management system according to claim 12,
wherein the energy storage system (ESS) is a VIB ESS including a vanadium ion battery (VIB), and
wherein, when an error or a failure occurs in the BMS, a state of charge (SoC) of the vanadium ion battery (VIB) is instead measured by using at least one sensor of the sensor network.

19. The energy storage system (ESS) management system according to claim 12, wherein the energy storage system (ESS) is physically or functionally integrated together with an electric vehicle charger.

20. The energy storage system (ESS) management system according to claim 19, further comprising:
a load other than the ESS in the entire system in which the energy storage system (ESS) is installed,
wherein it is judged whether the energy storage system (ESS) supplements the power grid and discharges the power to the electric vehicle charger according to measurement by the sensor network for the load other than the ESS.

21. The energy storage system (ESS) management system according to claim 12,
wherein a grid separation device is installed at a place where it is judged or predicted that power providing related noise is a lot or unstable according to measurement data of the sensor network.
